(19) United States
(12) Patent Application Publication
(10) Pub. No.: US 2011/0226942 A1
(43) Pub. Date: Sep. 22, 2011

(54) COMPOSITIONS, KITS, AND METHODS FOR CALIBRATION IN MASS SPECTROMETRY

(75) Inventors: MAHBOD R. HAJIVANDI, VISTA, CA (US); ROBERT M. POPE, CORALVILLE, IA (US); MEHRNOOSH SADEGHI, ALISO VIEJO, CA (US); XIQUAN LIANG, ESCONDIDO, CA (US); JOHN F. LEITE, VISTA, CA (US)

(73) Assignee: LIFE TECHNOLOGIES CORPORATION, CARLSBAD, CA (US)

(21) Appl. No.: 13/008,879

(22) Filed: Jan. 18, 2011

Related U.S. Application Data
(63) Continuation of application No. 11/131,744, filed on May 17, 2005, now abandoned.
(60) Provisional application No. 60/572,215, filed on May 17, 2004.
(60) Provisional application No. 60/572,290, filed on May 17, 2004.
(60) Provisional application No. 60/621,685, filed on Oct. 26, 2004.
(60) Provisional application No. 60/621,686, filed on Oct. 26, 2004.
(60) Provisional application No. 60/669,373, filed on Apr. 8, 2005.

(30) Foreign Application Priority Data
May 17, 2005 (US) PCT/US05/17391

(51) Int. Cl. H01J 49/26; G01N 31/00; H01J 49/00

(52) U.S. Cl. 250/282; 436/15; 250/252.1

(57) ABSTRACT

The invention provides compositions, kits, and methods for calibrating a mass spectrometer using two or more recombinant proteins and one or more energy-absorbing molecules. The recombinant proteins of the invention display high purities, making them suitable for use in mass spectrometry.

### FIELD OF THE INVENTION

The present invention is in the field of mass spectrometry and relates particularly to the calibration of mass spectrometers using recombinant protein calibrants.

### BACKGROUND OF THE INVENTION

Mass spectrometry provides a rapid and sensitive technique for the characterization of a wide variety of molecules. In the analysis of peptides and proteins, mass spectrometry can provide detailed information regarding, for example, the molecular mass (also referred to as “molecular weight” or “MW”) of the original molecule, the molecular masses of peptides generated by proteolytic digestion of the original molecule, the molecular masses of fragments generated during the ionization of the original molecule, and even peptide sequence information for the original molecule and fragments thereof.

A time-of-flight mass spectrometer determines the molecular mass of chemical compounds by separating the corresponding molecular ions according to their mass-to-charge ratio (the “m/z value”). Ions are accelerated in the presence of an electrical field, and the time necessary for each ionic species to reach a detector is determined by the spectrometer. The “time-of-flight” values obtained from such determinations are inversely proportional to the square root of the m/z value of the ion. Molecular masses are subsequently determined using the m/z values once the nature of the charged species has been elucidated.

Various formats for mass spectrometry are known. Direct laser desorption/ionization of biomolecules, such as polypeptides and nucleic acids, generally results in the fragmentation of the biomolecule and the consequent inability to obtain information about the intact species. To achieve desorption and ionization of intact biomolecules having molecular masses into the hundreds-of-thousands, various techniques have been used. In matrix assisted laser desorption/ionization mass spectrometry (“MALDI”), see, e.g., U.S. Pat. Nos. 5,118,937 and 5,045,694, the biomolecules are mixed in solution with an energy-absorbing organic molecule, referred to as a “matrix”. The matrix is allowed to crystallize on a mass spectrometry probe, capturing biomolecules within the matrix. In surface enhanced laser desorption/ionization mass spectrometry (“SELDI”), see, e.g., U.S. Pat. No. 5,719,060, biomolecules are captured by adsorbents bound to a solid phase, and a matrix solution may then be applied to the captured biomolecules.

Other techniques, such as electrospray ionization (“ESI”), see, e.g., Fenn et al. (1989) Science 246: 64-71, may also be used to ionize large biomolecules with little or no fragmentation. In ESI, ions may be produced directly from solution within an atmospheric interface to a mass spectrometer. The method allows a liquid fractionation technique, such as capillary electrophoresis or HPLC, to be coupled to a mass spectrometric analysis.

Mass spectrometers are extremely precise and must be carefully calibrated. Systematic errors, such as changes in the electrical field strength responsible for accelerating the ions, may cause errors in the time-of-flight values and thus in the calculated m/z values. Calibration may be effected by either an external calibration method, in which the m/z value for one or more calibrants is measured separately from that of the analyte of interest, or an internal calibration method, in which the one or more calibrants is added directly to the sample, and the m/z values for the calibrants and the analyte of interest are measured simultaneously. Alternatively, the calibrant and analyte of interest may be crystallized at separate locations on a probe. In any of these methods, the calibrants have known mass and form ions with known m/z values. Time-of-flight values obtained for the calibrants are used to correct the time-of-flight value of the analyte of interest. Methods and kits for the calibration of mass spectrometers have been described. See, e.g., U.S. Pat. No. 4,847,493; U.S. Patent Application Publication No. 2002/0033447; U.S. Patent Application Publication No. 2002/0045269; U.S. Patent Application Publication No. 2003/0062473. Calibration kits are also commercially available. See, e.g., ProteoMass™ Peptide and Protein MALDI-MS Calibration Kit (Sigma-Aldrich, St. Louis, Mo., USA); Mass Standards Kit (Applied Biosystems, Foster City, Calif., USA); MassPREP™ reference standards (Waters, Milford, Mass., USA); Protein Calibration Standard 1,20,000-70,000 Da (Bruker Daltonics, Billerica, Mass., USA); All-in-1 Protein Standard (Ciphergen, Fremont, Calif., USA).

A set of calibrants for use in calibrating a mass spectrometer should ideally include calibrants having molecular masses both above and below the molecular mass of the analyte of interest. In addition, because calibration curves are not linear, it is advantageous to include calibrants that have masses close to the molecular mass of the analyte of interest but that do not overlap and therefore obscure the analyte of interest. In addition, useful calibrants should be highly purified and free of interfering salts, buffers, and detergents that are commonly used in biological samples. They should also be stable under various conditions, should provide high resolution spectra, and should form relatively few adducts with salts and matrix molecules.

Although central to proteomic analysis, the use of mass spectrometry, particularly for the analysis of proteins having high molecular mass, has traditionally been expensive, inaccurate, imprecise, and irreproducible, in part because of the lack of suitable calibrants. There is thus a need in the art for improved calibrant compositions, kits, and methods of using calibrants in the analysis of biomolecules by mass spectrometry.

### SUMMARY OF THE INVENTION

The present invention solves these and other problems by providing improved calibrant compositions, kits, and methods of use. In one aspect, the calibrant compositions comprise a plurality of recombinant proteins spanning a predefined molecular mass range that are separated by one or more molecular mass increments and further comprise an energy-absorbing molecule. The recombinant proteins of the calibrant compositions may in another aspect span a predefined pI range and be separated by one or more pI increments. In still another aspect, the recombinant proteins of the calibrant compositions may span a predefined hydrophobicity range and be separated by one or more hydrophobicity increments.

In another aspect of the invention, the calibrant compositions comprise a plurality of recombinant proteins spanning a predefined molecular mass range that are separated by one or more molecular mass increments and that are homogeneous by mass spectrometry.

In yet another aspect, the invention provides kits comprising a plurality of recombinant proteins spanning a predefined molecular mass range and separated by one or more molecular mass increments and further comprising an energy-absorbing molecule. The kits may in some aspects comprise a plurality of recombinant proteins spanning a predefined pI range and separated by one or more pI increments. The recombinant proteins may span a predefined hydrophobicity and be separated by one or more hydrophobicity increments.

In another aspect, the invention provides compositions for improving the mass spectrometry profile of low abundance or high molecular weight analytes analyzed by matrix assisted laser desorption/ionization mass spectrometry (MALDI). In a preferred embodiment, the composition includes a matrix additive that can improve the signal-to-noise ratio of a mass spectrum.

In still other aspects, the invention provides methods of calibrating a mass spectrometer using the provided calibrant compositions. In one aspect, the calibrant composition is used as an external standard. In another aspect, the calibrant composition is used as an internal standard. In yet another aspect, the calibrant composition and an analyte of interest are crystallized at separate locations on a probe.

The details of various aspects of the invention are set forth in the accompanying drawings and the description below. Other features, objects, and advantages of the invention will be apparent from the description and claims.

### BRIEF DESCRIPTION OF THE DRAWINGS

FIG. 1 shows a protocol for purifying protein calibrants, where the purification is monitored by SDS-polyacrylamide gel electrophoresis.

FIG. 2 shows a modified protocol for purifying protein calibrants.

FIG. 3 shows MALDI mass spectra of the 50-kDa protein calibrant. Panel A shows the results using a sample purified by standard methods. Panel B shows the results using a sample obtained by mass spectrometry-directed purification as described in this invention.

FIG. 4 shows a MALDI mass spectrum of the 90-kDa protein calibrant and phosphorylase B (in 0.1% TFA).

FIG. 5 shows a MALDI mass spectrum of the 30-kDa protein calibrant reconstituted in 0.1% TFA, after acetone precipitation.

FIG. 6 shows a MALDI mass spectrum of the 90-kDa protein calibrant in 2% SDS buffer, precipitated, and dissolved in 50% formic acid, 25% acetonitrile, 15% isopropanol, and 10% water, and diluted 1:1 with a MES buffer.

FIG. 7 shows a MALDI mass spectrum of the 90-kDa protein calibrant in 7 M urea, 100 mM Na₃PO₄, pH=7.3, dialyzed against 0.1% TFA.

FIG. 8 shows a protocol for purifying protein calibrants, where the purification is monitored by mass spectrometry.

FIG. 9 shows a MALDI mass spectrum of the fraction with the highest purity of the 30-kDa protein calibrant collected off of the Ni-column (Fraction #7).

FIG. 10 shows a MALDI mass spectrum of the fraction with the highest purity of the 50-kDa protein calibrant collected off of the Ni-column (Fraction #7).

FIG. 11 shows a MALDI mass spectrum of the fraction with the highest purity of the 70-kDa protein calibrant collected off of the Ni-column (Fraction #7).

FIG. 12 shows a MALDI mass spectrum of the fraction with the highest purity of the 90-kDa protein calibrant collected off of the Ni-column (Fraction #7).

FIG. 13 shows a MALDI mass spectrum of the 160-kDa protein calibrant collected off of the Ni-column.

FIG. 14 shows a MALDI mass spectrum of the 30-kDa protein calibrant, internally calibrated with the [M+H]⁺ and [M+2H]²⁺ peaks of aldolase (ALFA_RABIT).

FIG. 15 shows a MALDI mass spectrum of the 90-kDa protein calibrant, internally calibrated with the [M+H]⁺ and [M+2H]²⁺ peaks of phosphorylase B (PHS2_RABIT).

FIG. 16 shows an external calibration of Cbx (VKGC_HUMAN) with the [3M+H]⁺ and [4M+H]⁺ peaks of the 30-kDa protein calibrant.

FIG. 17 shows a MALDI mass spectrum of the 50-kDa protein calibrant on (A) the day it was prepared and (B) 6 months later.

FIG. 18 shows a sample preparation protocol for the 30 kDa, 50 kDa, 70 kDa, and 90 kDa protein calibrants.

FIG. 19 shows a sample preparation protocol for the 160 kDa protein calibrant.

FIG. 20 shows MALDI mass spectra of the 160 kDa protein calibrant without (panel A) and with (panel B) MES and ammonium citrate in the matrix solvent.

FIG. 21 shows MALDI mass spectra of the 30 kDa, 50 kDa, 70 kDal and 90 kDa protein calibrants.

FIG. 22 provides images of 1 μL spots of SA dissolved in the absence or presence of MES, prepared and stored as described (A=freshly prepared sinapinic acid (SA); B=SA prepared as in A but stored 8 months at 8° C.; C═SA matrix in 40 mM MES stored at 8° C. for 8 months), and after the number of laser shots indicated on the left (1=200 laser shots; 2=10,000 laser shots; and 3=20,000 laser shots).

FIG. 23 depicts MALDI MS spectra of intact proteins (insulin, ubiquitin and cytochrome-c) co-spotted with SA only (A1-A3, B1-B3) or co-spotted with SA/40 mM MES (C1-C3). (A=freshly prepared sinapinic acid (SA); B=SA prepared as in A but stored 8 months at 8° C.; C═SA matrix in 40 mM MES stored at 8° C. for 8 months), and after the number of laser shots indicated on the left (1=200 laser shots; 2=10,000 laser shots; and 3=20,000 laser shots).

FIG. 24 provides mass spectrometry analysis of a HMW standard (159,081 Da) using (A) sinapinic acid dissolved in 0.1% TFA/50% ACN and (B) sinapinic acid dissolved in 40 mM MES.

FIG. 25 provides chemical structures of (A) sinapinic acid and MES and (B) MES, MOPS, MOPSO and MOBS.

### DETAILED DESCRIPTION

In a first aspect, the current invention provides novel compositions for the calibration of mass spectrometers. The calibrant compositions of the invention include recombinant proteins (also referred to as “polypeptides”) having molecular masses spanning a wide range of molecular mass at evenly-spaced, narrow intervals. The calibrant compositions may also include shorter peptides that are generated from the larger recombinant proteins. Any such protein calibrants may find use in many applications of mass spectrometry, including, but not limited to, those involving protein arrays, proteomics, and high throughput screening. Moreover, the novel compositions of the current invention may be useful in calibration and operational qualification of instruments coupled to mass spectrometry, either directly or indirectly, including capillary electrophoresis, HPLC, ion mobility interfaces, and devices for analyte enrichment or automated analysis. The compositions may further be useful in surface plasmon resonance analysis and in wavelength interrogated optical sensors.

### Recombinant Proteins

The calibrant compositions of the instant invention comprise a plurality of recombinant proteins having properties suitable for use in the calibration of a mass spectrometer, and one or more energy-absorbing molecules. The recombinant proteins of the instant calibrant compositions may be usefully produced, for example, as described in PCT International Publication No. WO98/30684; U.S. Pat. No. 6,703,484; U.S. Pat. No. 5,449,758; and U.S. Pat. No. 5,580,788, which are all hereby expressly incorporated by reference in their entireties. In particular, PCT International Publication No. WO98/30684 and U.S. Pat. No. 6,703,484 describe sets of protein standards comprising short multimerized repeats for the generation of a standard ladder with well-defined molecular weight intervals.

In certain embodiments, the compositions of the present invention may usefully comprise a plurality of recombinant protein species that differ in the number of copies of a repeating amino acid sequence, but that are otherwise similar to each other in primary sequence. The recombinant proteins may be comprised entirely of one or more copies of the repeat sequence, or may comprise at least one copy of the repeat sequence and additionally one or more copies of an additional sequence. That is, by way of nonlimiting example, if a recombinant protein with one copy of the amino acid sequence repeat has a MW of 12 kD, then a protein with two copies may have a MW of 24 kD, one with three copies may have a MW of 36 kD, etc.

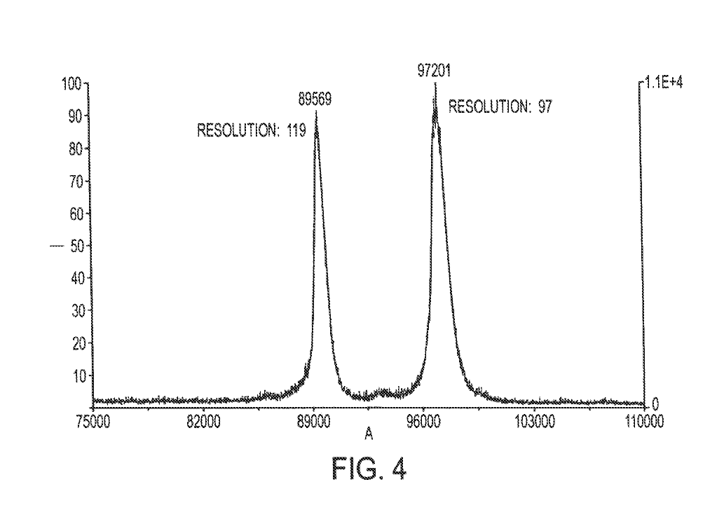

The recombinant proteins of the instant calibrant compositions may, for example, usefully be prepared by expression of the proteins as inclusion bodies in host cells. Thus, briefly, a series of fusion proteins may be made, wherein the fusion protein includes a protein, or fragment, portion, derivative or variant thereof, capable of forming inclusion bodies upon expression in a host cell (the “inclusion partner protein”). The inclusion partner protein is linked to one or more recombinant proteins or fragments thereof. For example, a nucleic acid molecule encoding a modified thioredoxin inclusion partner protein may be inserted into a vector, preferably an expression vector, to form a fusion vector such as plasmid pTrxA-concat (see FIG. 4, U.S. Pat. No. 6,703,484). This vector may then be linked to single or multiple fragments of a recombinant protein such as thioredoxin, E. coli Dead-Box protein, KpnI methylase, or 264-bp modified T4 gene 32 protein, each of a chosen size (e.g., 5 kD or 10 kD). After insertion of the nucleic acid molecule or vector into the host cell (i.e., transformation of the host cell), the recombinant proteins may then be produced by expression in the host cells, preferably in the form of inclusion bodies.

It will be apparent to one of ordinary skill in the art that several expression scenarios are possible. For example, the methods may be used to produce a nucleic acid molecule encoding a plurality of the polypeptides forming the recombinant protein mixture used in the calibrant composition, or to produce multiple nucleic acid molecules each of which encodes a different molecular weight polypeptide of the recombinant protein mixture. Host cells may then be transformed with the nucleic acid encoding a plurality of such polypeptides, or with the multiple nucleic acid molecules each encoding a different molecular weight polypeptide.

Alternatively, multiple host cells may be transformed, each with a single nucleic acid molecule encoding a different polypeptide of the recombinant protein mixture; in this scenario, polypeptides produced by the host cells will be admixed to form the recombinant protein mixture. In each of these scenarios, expression of these constructs will preferably produce inclusion bodies in the host cells comprising polypeptides from as small as 5-10 kD to as large as 250-330 kD.

Furthermore, the molecular mass range and increments of the recombinant proteins used in the calibrant compositions of the instant invention may be defined by simply altering the length or number of copies of the recombinant polypeptide gene linked to the inclusion partner protein gene fusion construct. Thus, it is possible according to the present invention to produce a calibrant composition comprising a collection of recombinant proteins having a lower molecular mass of, for example, about 50 kD, 45 kD, 40 kD, 35 kD, 30 kD, 25 kD, 20 kD, 15 kD, 10 kD, 5 kD, or even lower. The calibrant composition of the present invention may likewise comprise, for example, a collection of recombinant proteins having an upper molecular mass of, for example about 30 kD, 35 kD, 40 kD, 45 kD, 50 kD, 55 kD, 60 kD, 65 kD, 70 kD, 80 kD, 90 kD, 100 kD, 110 kD, 120 kD, 140 kD, 160 kD, 180 kD, 200 kD, 220 kD, 250 kD, 300 kD, or even higher.

In some embodiments, the recombinant proteins of the instant invention may be expressed as part of a chimeric or multimeric protein. A recombinant chimeric protein comprises protein sequences derived from different source proteins. A recombinant multimeric protein can comprise multiple repeats of one or more protein sequences, or can comprise the sequence of an entire protein multimerized in tandem. Preferably two or more recombinant proteins in a calibrant composition are either chimeric or multimeric proteins. The chimeric or multimeric proteins may be fragmented, for example by proteolysis or by any other fragmentation method, to generate the recombinant proteins of the calibrant compositions. The chimeric or multimeric proteins are preferably purified away from contaminating materials prior to the fragmentation step. In some embodiments, the chimeric or multimeric proteins may include one or more post-translational modification sites, such that the proteins generated upon fragmentation contain a modification of interest. In some embodiments, the modification of interest consists of one or more glycosylations. In other embodiments, the modification site may be recognized and modified by protein or peptide kinases.

The recombinant proteins of the instant calibrant compositions may range in molecular mass from about 5 kD to about 300 kD, preferably from about 5 kD to about 250 kD, and more preferably from about 10 kD to about 220 kD, and may reflect maximum molecular mass increments of, for example, about 5 kD, 10 kD, 20 kD, 25 kD, 50 kD, 100 kD, or even larger. Of course, it will be understood by one of ordinary skill that other molecular mass ranges and maximum molecular mass increments may be more suitable for certain applications and may be prepared by routine modification of the described methods (such as by increasing or decreasing the length of the gene encoding the fused recombinant polypeptide as described above).

Calibrant sets of the present invention can be designed to span molecular weight ranges of interest, such that the molecular weights of two of the recombinant proteins of a set of protein calibrants can be, as nonlimiting examples: about 10 kD and about 30 kD; about 10 kD and about 50 kD; about 10 kD and about 70 kD; about 10 kD and about 90 kD; about 10 kD and about 100 kD; about 10 kD and about 120 kD; about 10 kD and about 160 kD; about 20 kD and about 50 kD; about 20 kD and about 70 kD; about 20 kD and about 90 kD; about 20 kD and about 100 kD; about 20 kD and about 120 kD; about 20 kD and about 160 kD; about 30 kD and about 50 kD; about 30 kD and about 70 kD; about 30 kD and about 90 kD; about 30 kD and about 100 kD; about 30 kD and about 120 kD; about 30 kD and about 160 kD; about 50 kD and about 70 kD; about 50 kD and about 90 kD; about 50 kD and about 100 kD; about 50 kD and about 120 kD; about 50 kD and about 160 kD; about 70 kD and about 90 kD; about 70 kD and about 100 kD; about 70 kD and about 120 kD; about 70 kD and about 160 kD; about 90 kD and about 100 kD; about 90 kD and about 120 kD; about 90 kD and about 160 kD; about 100 kD and about 120 kD; about 100 kD and about 160 kD; and about 120 kD and about 160 kD.

For example, a calibrant composition that can comprise two or more recombinant proteins with molecular masses between about 10 kD and about 30 kD, where at least two of the recombinant proteins with molecular masses between about 10 kD and about 30 kD are separated by a molecular mass increment of about 5 kD.

It is intended that molecular mass increment refer to the difference in molecular mass between adjacent proteins in a specified series of protein calibrants. It will be understood that the molecular mass increments separating proteins in a specified series of protein calibrants may not necessarily be a single fixed value but will preferably have a maximum value for a given protein series.

In some preferred embodiments, however, the protein calibrants can comprise three or more proteins, where two or more molecular mass increments that separate the calibrants are essentially the same. For example, a protein calibrant set can have two or molecular mass increments of 10 kDa, or two or more molecular mass increments of 20 kDa. In a preferred embodiment, the calibrant composition comprises three or more recombinant proteins, where the same molecular mass increment separates at least three adjacent recombinant proteins. In another embodiment, the protein calibrants can comprise four or more proteins, in which three or more adjacent calibrant proteins are separated by the same molecular mass increment, for example, 10 kDa or 20 kDa.

In yet other aspects, the protein calibrants can be separated by molecular mass increments of increasing magnitude as the size of the protein calibrants increases. Thus, in a calibrant composition comprising four or more proteins, where the first through fourth proteins are of increasing molecular weight, a first and a second protein can be separated by 5 kDa, a second and third protein can be separated by 10 kDa, and a third and fourth protein can be separated by 20 kDa.

The calibrant compositions may therefore include a plurality of recombinant proteins having molecular masses spanning a predefined molecular mass range and separated by one or more molecular mass increments, where the predefined range and separation increments are usefully chosen as appropriate for a particular analyte or mixture of analytes of interest and for a particular application of interest.

The amino acid sequences of one or more of the recombinant proteins of the current invention may also be modified by proteolytic processing after isolation to generate proteins or peptides with particular chemical, physical, or other properties. Such modifications may be accomplished by techniques that are well known in the art. A combination of sequence modification and specific protease cleavage may be used to generate protein fragments with desirable range of physical properties, such as hydrophobicity, isoelectric point, mass, net charge, charge distribution, or any other property of the protein. Such changes may, for example, allow a protein to be distinguished chemically, physically, or in some other manner from other proteins in a sample, either prior to, or during, the mass spectroscopic analysis. As is well known in the art, analytical techniques and computational methods may be used to categorize the various proteins according to their chemical and physical properties. Such techniques may be used, for example, to mix individual recombinant proteins into useful combinations for purposes of instrument calibration. These techniques may also be used to create proteins or protein fragments that have a desirable distribution of post-translational modifications.

Accordingly, the calibrant compositions of the instant invention may include recombinant proteins or peptide fragments thereof having a lower pI of, for example, about 12, 11, 10, 9, 8, 7, 6, 5, 4, 3, 2, 1, or even lower. The compositions may likewise include recombinant proteins having an upper pI of, for example, about 2, 3, 4, 5, 6, 7, 8, 9, 10, 11, 12, 13, 14, or even higher. The maximum increment in pI values separating the various recombinant proteins of the instant calibrant compositions may be about 0.2, 0.5, 1, 2, 3, 4, or even larger.

A pI range calibrant composition comprises recombinant proteins that are homogeneous as assayed by mass spectrometry. Preferably a pI calibrant composition comprises three or more recombinant proteins or peptides, more preferably comprises four or more recombinant proteins or peptides, and more preferably yet, five or more recombinant proteins or peptides. The pI range calibrant composition can be one or more recombinant proteins that can be digested to generate peptides with desired pIs. Recombinant proteins can be designed to contain one or more protease recognitions sites to generate peptides with pIs of a particular value. Amino acids within a recombinant protein can be added, deleted, or substituted to design the protein or peptides resulting from digestion of the protein to have a desired pI.

The pI calibrants can be used to calibrate liquid chromatography or capillary electrophoresis linked to mass spectrometry, where fractions of a complex sample separated by liquid chromatography or capillary electrophoresis are analyzed using mass spectrometry, such as, for example, electrospray ionization (ESI) mass spectrometry. By calibrating the LC or electrophoresis separation step to pI, the pI of a protein or peptide identified by MS and separating in the same chromatography or electrophoresis fraction as a calibrant can be determined.

The invention includes methods of calibrating separation chromatography or capillary electrophoresis linked to mass spectrometry by applying one or more recombinant proteins designed for pI calibration or peptides generated from one or more recombinant proteins designed for pI calibration to at least one separation column or capillary electrophoresis apparatus linked to a mass spectrometer, performing chromatography or capillary electrophoresis on the one or more recombinant proteins or peptides to separate the one or more recombinant proteins or peptides into one or more chromatography or electrophoresis fractions, and performing mass spectrometry on the chromatography or capillary electrophoresis fractions to obtain one or more mass spectrometry profiles of the one or more chromatography or capillary electrophoresis fractions. Preferably the method further includes correlating the mass spectrometry profiles with column separation conditions of the one or more chromatography fractions to calibrate the separation conditions with the pI of the one or more recombinant proteins or peptides.

Similarly, the hydrophobicity of the recombinant proteins of the instant invention may usefully be varied. The hydrophobicity of a particular protein may be assessed functionally, for example, by measurement of retention time on reverse-phase or hydrophobic interaction chromatography. Alternatively, the hydrophobicity of a protein or subsequence of a protein may be determined by calculation. See, e.g., Kyte et al. (1982) J. Mol. Biol. 157:105-32; Eisenberg et al. (1984) J. Mol. Biol. 179:125-42; Champney (1990 J Chromatogr. 522: 163-170; and Guo et al. (1987) J Chromatogr. 386: 205-222, each of which is incorporated herein in its entirety. Such calculations are within the skill of an ordinary artisan.

A hydrophobicity range calibrant composition comprises recombinant proteins that are homogeneous as assayed by mass spectrometry. Preferably a hydrophobicity calibrant composition comprises three or more recombinant proteins or peptides, more preferably comprises four or more recombinant proteins or peptides, and more preferably yet, five or more recombinant proteins or peptides.

The hydrophobicity calibrants can be used to calibrate reverse phase liquid chromatography linked to mass spectrometry, where fractions of a complex sample separated by reverse phase chromatography are analyzed using mass spectrometry, such as, for example, electrospray ionization (ESI) mass spectrometry. By calibrating the chromatography separation step to hydrophobicity, the hydrophobicity of a protein or peptide identified by MS and separating in the same chromatography or electrophoresis fraction as a calibrant can be determined.

The invention includes methods of calibrating reverse phase chromatography linked to a mass spectrometry by applying one or more recombinant proteins designed for hydrophobicity calibration or peptides generated from one or more recombinant proteins designed for hydrophobicity calibration to at least one reverse phase separation column linked to a mass spectrometer, performing reverse phase chromatography on the one or more recombinant proteins or peptides to separate the one or more recombinant proteins or peptides into one or more chromatography fractions, and performing mass spectrometry on the chromatography fractions to obtain one or more mass spectrometry profiles of the one or more chromatography fractions. Preferably the method further includes correlating the mass spectrometry profiles with column separation conditions of the one or more chromatography fractions to calibrate the separation conditions with the hydrophobicity of the one or more recombinant proteins or peptides.

It will be understood that the sequence modifications used to effect changes in the chemical or physical properties of a protein may be limited to particular subsequences within a protein molecule or may be distributed throughout the primary sequence of the protein. It will further be understood that any such sequence modification may alter the molecular mass of the protein. Such effects on molecular mass may, however, be countered by compensating changes in sequence at other locations if so desired. In some embodiments of the invention, changes may be made both in a chemical, physical, or other property of a protein and in the molecular mass of the protein.

In some embodiments, the calibrant compositions of the instant invention may include a mixture of two recombinant proteins. In other embodiments, the calibrant compositions may include three, four, five, six, seven, eight, or even more recombinant proteins.

Exemplary proteins comprising varying multiples of one or more repeat domains that may usefully be adapted for use in the present invention, include the proteins of the BenchMark™ Protein Ladder (Invitrogen Corp., Carlsbad, Calif.); the Ladder comprises 15 engineered proteins ranging in molecular weight from 10 to 220 kD. On a 4-20% SDS polyacrylamide gel electrophoresis (“SDS-PAGE”) gradient gel stained with 0.1% (w/v) Coomassie Brilliant Blue R®-250, the bands have apparent molecular weights of 10, 15, 20, 25, 30, 40, 50, 60, 70, 80, 90, 100, 120, 160, and 220 kD. The 20 kD and 50 kD bands have greater intensity than the other bands to facilitate visual identification of the respective bands in the ladder on a stained gel. The proteins of the BenchMark™ Protein Ladder contain relatively few amino acids subject to artifactual modification, such as cysteine and methionine, and therefore display improved resolution on mass spectrometry than natural proteins. The usefulness of the proteins of the BenchMark™ Protein Ladder as calibrants in mass spectrometry is further improved by increasing the purity of the proteins beyond that necessary for use of the proteins as molecular weight standards in SDS-PAGE.

Another series of multimer-containing protein embodiments that may usefully be adapted for use in the present invention includes proteins having one or more copies of an immunoglobulin (Ig) constant region (Fc)-binding domain, such as the IgFc-binding domain from protein G or protein A. Recombinant fusions to Protein G and Ig-binding fragments of Protein G are described, e.g., in U.S. Pat. Nos. 5,082,773 and 5,108,894, the disclosures of which are incorporated herein by reference in their entireties. Such proteins usefully bind antibodies of the appropriate classes without regard for the antigen specificity of the antibody.

Used as standards on a Western blot, such standards may thus be visualized with the same antibody as that used to visualize the sample protein of interest.

Exemplary proteins comprising one or more Ig Fc-binding domains that may usefully be adapted for use in the present invention include the proteins of the MagicMark™ protein ladder, MagicMark™ XP protein ladder, and E-PAGE™ MagicMark™ protein ladder (all from Invitrogen Corp., Carslbad, Calif.). In each of these products, each protein present in the composition includes at least one Ig-Fc binding region.

The MagicMark™ protein ladder comprises nine proteins of known molecular weight, i.e., 20 kD, 30 kD, 40 kD, 50 kD, 60 kD, 80 kD, 100 kD, 120 kD; the MagicMark™ XP standard additionally contains a tenth protein of 220 kD. In contrast, the E-PAGE™ MagicMark™ protein ladder comprises five proteins having molecular weights of 20 kD, 40 kD, 60 kD, 120 kD, and 220 kD. That is, the E-PAGE™ MagicMark™ protein ladder is prepared essentially as are the MagicMark™ and MagicMark® XP protein ladders, with the exception that protein standards having molecular weights of 30 kD, 50 kD, 80 kD and 100 kD are omitted from the formulation.

In addition to the above-described methods, variable repeat-containing proteins can also be prepared using the recombinational cloning approach embodied within the Gateway® system (Invitrogen Corp., Carlsbad, Calif.), as further described in commonly owned U.S. Pat. Nos. 6,270,969, 6,171,861, 6,143,557, and 5,888,732; commonly owned U.S. Patent Application Publication Nos. 2003/0100110, 2003/0068799, 2003/0064515, and 2003/0054552; and commonly owned PCT International Publication No. WO 96/40724 A1, the disclosures of which are incorporated herein by reference in their entireties.

In yet another approach, variable repeat-containing proteins that may usefully be adapted for use in the present invention may be prepared using a flp-based system, as further described in Sadowski et al., BMC Biotechnology 3:9 (2003), the disclosure of which is incorporated herein by reference in its entirety.

### Vectors

The vectors expressing the proteins used in the calibrant compositions of the present invention may be, for example, phage, plasmid, or phagemid vectors, and are preferably plasmids. Preferred are vectors comprising cis-acting control regions to the nucleic acid encoding the polypeptide of interest. Appropriate trans-acting factors may be supplied by the host, supplied by a complementing vector or supplied by the vector itself upon introduction into the host.

In certain preferred embodiments in this regard, the vectors provide for specific expression, which may be inducible and/or cell type-specific. Particularly preferred among such vectors are those inducible by environmental factors that are easy to manipulate, such as temperature and nutrient additives.

Expression vectors useful in the present invention include chromosomal-, episomal- and virus-derived vectors, e.g., vectors derived from bacterial plasmids or bacteriophages, and vectors derived from combinations thereof, such as cosmids and phagemids. The DNA insert encoding a calibrant protein is preferably operatively linked to an appropriate promoter, such as the phage T7 promoter, the phage lambda P_{L} promoter, the E. coli lac, trp, tac, araBAD, and trc promoters.

Other suitable promoters are known to the skilled artisan. The gene fusion constructs may further contain sites for transcription initiation, termination, and, in the transcribed region, a ribosome binding site for translation. The coding portion of the mature transcripts expressed by the constructs preferably includes a translation initiation codon at the beginning, and a termination codon (UAA, UGA or UAG) appropriately positioned at the end, of the polynucleotide to be translated.

The expression vectors preferably include at least one selectable marker. Such markers include tetracycline or ampicillin resistance genes for culturing in E. coli and other bacteria.

Prokaryotic expression systems suitable for use in the expression of the calibrant compositions of the instant invention may be obtained commercially; e.g., the T7 Expression System, the pBAD Expression System, the ThioFusion™ Expression System, the trc Expression System, the P_{L} Expression System, and the PurePro™ Caulobacter Expression system (Invitrogen Corp., Carlsbad, Calif.). Among vectors currently preferred for use in the present invention are pQE70, pQE60 and pQE-9, available from Qiagen; pBS vectors, Phagescript vectors, Bluescript vectors, pNH8A, pNH16a, pNH18A, pNH46A, available from Stratagene; and pET-DEST42 Gateway®, pDEST™14, pDEST™15, pDEST™17, pDEST™24, pET100/D-TOPO®, pET101/D-TOPO®, pET102/D-TOPO®, pRSET A, B, & C, pRSET-E Echo™, pCR®T7-E Echo™, pBAD102/D-TOPO®, pBAD202/D-TOPO®, pBAD/Thio-TOPO®, pBAD-DEST49 Gateway®, pBAD-TOPO®, pBAD/His A, B, & C, pBAD/Myc-His A, B, & C, pBAD/gIII A, B, & C, pBAD/Thio-E Echo™, pThioHis A, B, & C, pTrcHis-TOPO®, pTrcHis2-TOPO®, pTrcHis A, B, & C, pTrcHis2 A, B, & C, pLEX, and pCX-TOPO® available from Invitrogen. Other suitable vectors will be readily apparent to the skilled artisan.

In some cases, yeast expression systems may be useful for the expression of the recombinant proteins of the instant calibrant compositions. For example, the Pichia Expression Systems, the YES™ Vector Collection, and the SpECTRA™ S. pombe Expression System (Invitrogen Corp., Carlsbad, Calif.), or others, may be used. In other cases, insect expression systems, such as, for example, the BaculoDirect™ Baculovirus Expression System, the Bac-to-Bac® Baculovirus Expression System, the Bac-N-Blue™ Baculovirus Expression System, the Drosophila Expression System (DES®), and the InsectSelect™ System (Invitrogen Corp., Carlsbad, Calif.), or others, may be used. In still other cases, it may be useful to express the recombinant calibrant proteins in mammalian cells.

### Host Cells

Representative examples of host cells appropriate for the expression of the instant recombinant calibrant proteins include, but are not limited to, bacterial cells such as E. coli, Streptomyces spp., Erwinia spp., Klebsiella spp., Salmonella typhimurium, and Caulobacter crescentus. Preferred as a host cell is E. coli, and particularly preferred are E. coli strains BL21(DE3), BL21-Star™ (DE3), BL21-AI™, TOP10, LMG194, GI724, which are available commercially (Invitrogen Corp., Carlsbad, Calif.). Other preferred E. coli strains are DH10B c1 and STBL2. In some cases the strains further contain other plasmids, such as, for example, pLysS or pLysE, for reduction of basal expression of recombinant proteins or for other reasons. Other examples of appropriate host cells for use in the expression of the recombinant proteins of the invention include yeast cells, insect cells, and mammalian cells.

### Expression and Purification of Recombinant Proteins

The recombinant proteins of the instant invention are expressed in host cells or in cell-free systems and may be purified by any suitable method. Many such methods are known to those of skill in the biochemical sciences. For example, the proteins may be expressed as inclusion bodies in bacterial host cells as described, for example, in PCT International Publication No. WO98/30684. Following rupture of the cells, inclusion bodies are separated from cellular debris using suitable separation techniques such as centrifugation. Proteins contained in the inclusion bodies are subsequently solubilized using a denaturing agent and may be, if attached as a fusion protein to an inclusion partner protein, treated with a cleavage agent to remove the partner protein. In some cases, the denatured protein may be renatured prior to further purification. In some embodiments, the recombinant proteins may be expressed in cell-free system. Such systems may facilitate, for example, the incorporation of labels or other useful probes into the expressed proteins. In a preferred embodiment, proteins expressed in a cell-free system are labeled using heavy isotopes.

The recombinant proteins may in some embodiments require further purification and processing prior to their use. The proteins may be purified by any of a variety of protein purification techniques that are well known to one of ordinary skill in the art. Suitable techniques for purification include, but are not limited to, ammonium sulfate or ethanol precipitation, acetone precipitation, acid extraction, electrophoresis, isoelectric focusing (“IEF”), immunoadsorption, anion or cation exchange chromatography, phosphocellulose chromatography, hydrophobic interaction chromatography, affinity chromatography, immunoaffinity chromatography, size exclusion chromatography (“SEC”), liquid chromatography (“LC”), high performance LC (“HPLC”), fast protein LC (“FPLC”), hydroxylapatite chromatography, lectin chromatography, immobilized metal affinity chromatography (“IMAC”), metal chelation chromatography, and continuous flow electrophoresis (“CFE”). Preferably, the proteins are modified to contain one or more histidine tags and are purified using metal chelation chromatography and, in some embodiments, are further purified by CFE.

Proteins with Improved Homogeneity

In preferred embodiments of the invention, each of the recombinant proteins present in a calibrant composition is purified to homogeneity, either individually or as a mixture. The purity of the purified recombinant proteins is preferably assessed by analysis of the proteins using mass spectrometry. Alternatively, the purity may be assessed using SDS-PAGE. For purposes of the present invention, a protein is considered homogeneous when the intensity of any contaminant peak in a MALDI mass spectrometric analysis displays less than 20% of the signal intensity of the peak corresponding to the [M+H]⁺ ion of the protein of interest. Contaminants may include molecules unrelated to the protein of interest as well as fragments and other structurally distinct forms of the protein but do not include other molecular ionic forms of the protein. Routine analysis of fractionations by mass spectrometry during the purification process allows improved resolution of the protein of interest and increased protein homogeneity.

In some embodiments, the homogeneity may be improved by eliminating or modifying one or more post-translational modifications on one or more of the recombinant proteins included in the composition. This can be done chemically, enzymatically, or by engineering the sequence encoding a recombinant protein to remove sites in the amino acid sequence that can be recognized by modifying enzymes, such as, but not limited to, glycosylases, kinases, or acetylases. In a highly preferred embodiment, one or more of the recombinant proteins of the calibrant composition is substantially free of heterogeneous post-translational modifications.

Changes in the post-translational modification of the proteins of the calibrant compositions may be made in vivo or in vitro. For example, the recombinant proteins may be chemically amidated in vitro. The following are representative teachings regarding chemical amidation that may be used to practice the invention: Bradbury et al. (1991) Trends Biochem Sci 16:112-115; Eipper et al. (1988) Annu. Rev. Physiol. 50:333-344.

The recombinant proteins may also be enzymatically amidated. The following are representative teachings regarding enzymatic amidation that may be used to practice the invention: Wu et al. (2000) Acta Biochemica et Biophysica Sinica (Shanghai) 32:312-315, which describes recombinant rat peptidylglycine alpha-amidating monooxygenase (rPAM); Merkler (1994) Enzyme Microb. Technol. 16:450-456; Breddam et al. (1991) Int. J. Pept. Protein Res. 37:153-160.

In other embodiments, the recombinant proteins may be deamidated using amidohydrolases.

According to the categorical numbering system of EC (Schomburg, D. & Salzmann, M., eds. (1991) Enzyme Handbook 4 (Springer, Berlin)) that uses such properties as substrate specificity and physicochemical characteristics as criteria, amidohydrolases have been divided into two major types: 77 were included in the EC 3.5.1 category (EC 3.5.1.1-3.5.1.77), and 14 were placed under EC 3.5.2 (EC 3.5.2.1-3.5.2.14). Amidohydrolases that may be used to practice the invention include recombinantly produced amidohydrolases, which may be enantioselective. See, e.g., Fournand et al. (1998) Applied and Environmental Microbiology 64:2844-2852.

Although in preferred embodiments the recombinant proteins of the instant invention are produced in host cells lacking glycosylation pathways, proteins for use in the calibrant compositions may, if desired, be glycosylated or deglycosolated. Prozyme (San Leandro, Calif.), offers a GlycoFree™ Chemical Deglycosylation Kit.

Enzymes catalyzing the addition (O-GlcNAc transferase, OGT) and removal (O-GlcNAcase) of the N-glycosyl modification have been cloned and expressed using recombinant DNA technology. These and other enzymes of the disclosure may likewise be cloned for expression in bacterial hosts. Vosseller et al. (2001) Biochemie 83:575-581.

The following are representative of glycosylases and deglycosylases that may be used to practice the invention:

Enzymes available from New England Biolabs (Beverly,
MA)
N-Glycosidase F (PNGase F) from Flavobacterium
meningosepticum
Endoglycosidase H (Endo H)
Endo H_{f} (a protein fusion of Endo H and maltose binding
protein)
Enzymes available from Prozyme (San Leandro, CA)
Enzymatic Deglycosylation Kit
Glyko ® Enzymatic Deglycosylation Kit
Glyko ® Deglycosylation Plus
Ceramide-Glycanase from Marobdella decora
Sialidase from S. pneumoniae recombinant in E. coli
Sialidase from C. perfingens recombinant in E. coli
Sialidase from A. ureafaciens recombinant in E. coli
Beta-N-acetylhexosaminidase from S. pneumoniae
recombinant in E. coli
Alpha-Mannosidase from X. manihotis recombinant in E.
coli.
O-Glycanase from S. pneumoniae recombinant in E. coli
Endoglycosidase-H from S. plicatus recombinant in E.
coli
Beta-Galactosidase from X. manihotis recombinant in E.
coli.
Beta-Xylosidase from A. niger
Alpha-Fucosidase from X. manihotis recombinant in E.
coli.
Alpha-Fucosidase from A. niger recombinant in E. coli.
Chondroitinase ABC from P. vulgaris recombinant in A.
niger
Endo-beta-galactosidase from Bacteroides fragiles
Endoglycosidase H (recombinant)
PNGase F (Chryseobacterium [Flavobacterium]
meningosepticum)
Endo-alpha-N-acetylgalactosaminidase
Endoglycosidase-F1 from Flavobacterium meningosepticum
N-Glycanase (recombinant)
Endoglycosidase-F1 from Flavobacterium meningosepticum
Endoglycosidase-F2 from Flavobacterium meningosepticum
Endoglycosidase-F3 from Flavobacterium meningosepticum
N-Glycanase ™-PLUS PNGase F (recombinant)
Heparinase I (Flavobacterium heparinum)
Chondroitinase ABC
Chondroitinase ACI Rev 29 Dec. 1996
alpha-L-Iduronidase (Human liver - recombinant)
beta(1-3,4,6)-D-Glucuronidase (Bovine liver)
alpha-N-Acetylglucosaminidase (Human urine -
recombinant)
Iduronate-2-sulfatase (Human liver - recombinant)
Glucosamine-6-sulfatase (Caprine liver - recombinant)
Sulfamidase (Human liver - recombinant)
Galactosyltransferase
Fucosyltransferase
alpha-N-Acetylgalactosaminidase (Chicken liver)
beta(1-2,3,4,6)-N-Acetylhexosaminidase (Jack bean)
Beta-N-Acetylhexosaminidase
alpha(1-2,3,4,6)-Fucosidase (Bovine kidney)
alpha(1-3,4,6)-Galactosidase (Green coffee bean)
alpha-Mannosidase (Aspergillus saitoi)
alpha(1-2,3,6)-Mannosidase (Jack bean)
Sialidase (Arthrobacter ureafaciens)
beta(1-3,4,6)-Galactosidase (Jack bean)
beta(1-3,4)-Galactosidase (Bovine Testes)
beta(1-4)-Galactosidase (Streptococcus pneumoniae)
beta-Mannosidase (Helix pomatia)
Sialidase [Neuraminidase] (Clostridium perfingens)
Sialidase N ™(Newcastle disease virus, Hitchner B1
Strain)
Sialidase T ™(recombinant)
alpha(1-3,4)-Fucosidase (Almond meal)
Sialidase V ™(Vibrio cholerae)
Sialidase I (recombinant)
Sialidase (Arthobacter ureafaciens)

In yet other embodiments, the recombinant proteins for use in the calibrant compositions may be treated with one or more phosphatases. The following are representative of phosphatases that may be used to practice the invention:

members of the serine/threonine protein phosphatase family, including the prototype member, protein phosphatase-1 (phosphorylase phosphatase; originally named PR enzyme). For a review, see Lee et al. (1999) Frontiers in Bioscience 4:d270-285.

alkaline phosphatases, such as calf intestine alkaline phosphatase (Stratagene, Promega) and alkaline phosphatase from E. coli (CHIMERx, Milwaukee, Wis.).

In yet additional embodiments, the recombinant proteins of the instant invention may be treated with kinases. The following are representative of kinases that may be used in the practice of the invention:

members of the eukaryotic protein kinase (EPK) family, including human members (Kostich et al. (2002) Genome Biol. 3:research0043.1-0043.12.

members of the calmodulin-protein kinase family.

members of the mitogen-activated protein kinase (MAPK) family.

In yet other embodiments, recombinant proteins that are normally not phosphorylatable may be modified to render them phosphorylatable, if so desired (see U.S. Pat. No. 5,986,061), and then treated with one or more kinases.

In a variety of embodiments, the recombinant proteins of the present invention may include any one or more of the above-described alterations in or elimination of post-translational modification.

### Energy-Absorbing Molecules

Energy-absorbing molecules (“EAMs”) are molecules or agents that are capable of absorbing energy from an ionization source, such as a laser desorption ionization source, and thereafter contributing to the desorption and ionization of analyte in contact therewith. Few structural restrictions are placed upon the EAMs useful in practicing the present invention. In a most general embodiment, an EAM of the invention absorbs photo-irradiation from a high fluence source (e.g., laser, flash lamp) to generate thermal energy. The EAM then transfers the thermal energy to allow desorption and ionization of an analyte molecule that is in contact with or proximate to the EAM. The EAM may be supplied as part of the calibrant composition of the instant invention, or it may be provided separately and placed in contact with the composition by the user prior to or during use. The EAM may be a freely-soluble molecule, or it may be entrapped covalently or non-covalently within a polymer or other suitable carrier. In some cases, as further described below, the EAM may be predisposed on the mass spectrometry probe prior to the application of the calibrant proteins.

As stated above, the EAM may be provided together with a carrier. When the EAM is not covalently bonded to the carrier, it preferably interacts with the carrier via electrostatic, ionic, hydrophilic, hydrophobic, or van der Waals interactions. The EAM may also be entrapped within the carrier by virtue of its being too large to diffuse from or otherwise exit the carrier.

An EAM can be any energy-absorbing molecule useful in MALDI, including but not limited to, sinnapinic acid (dimethoxy hydroxycinnamic acid); alpha-cyano-4-hydroxycinnmic acid; 2,5 dihydroxybenzoic acid (2,5 DHB); 2-(4-hydroxy-phenol-azo)-benzoic acid (HABA); fucose mixtures with DHB; 2-hydroxy-5-methoxybenzoic acid; 5 methoxysalicylic acid; 2,4,6 trihydroxyacetophenone; 2,6 dihydroxyacetophenone; 3 hydroxypicolinic acid (HPA); cinnamide; cinnamyl bromide; or nicotinic acid. Sinnapinic acid (dimethoxy hydroxycinnamic acid) is a preferred EAM for mass spectrometry of proteins with molecular weights greater than about 5000 daltons.

Any matrix material, such as solid acids, including 3-hydroxypicolinic acid and alpha-cyano-4-hydroxycinnamic acid (a.k.a. gentisic acid, CHCA, 4-HCCA), and liquid matrices, such as glycerol, known to those of skill in the art for MALDI-TOF MS analyses is contemplated. Materials useful for matrix formulation include without limitation 4-HCCA (a.k.a. CHCA), sinapinic acid (SA), 2,5-dihydroxybenzoic acid (DHBA), 3-hydroxy-picolinic acid (HPA) (all available from, e.g., Sigma-Aldrich, St. Louis, Mo.) and nor-harmane (Sigma). Generally, nor-harmane is prepared as a 10 mg/ml solution in 50% acetonitrile/50% water for aqueous soluble molecules, tetrahydrofuran for polymers and chloroform for lipids. Energy-absorbing molecules include all molecules so called in U.S. Pat. Nos. 5,719,060, 5,894,063, 6,020,208, and 6,027,942, as well as those mentioned in Harvey David, J., Mass Spectrometry Reviews, 1999, 18, 349-451, the disclosures of which are incorporated herein by reference in their entireties.

The term EAM explicitly includes cinnamic acid derivatives, sinapinic acid, cyano hydroxy cinnamic acid, and dihydroxybenzoic acid.

### Probes

A probe in the context of the instant invention typically refers to a device that may be used to introduce ions derived from an analyte into a gas phase ion spectrometer, such as a mass spectrometer. A probe typically comprises a solid substrate (either flexible or rigid) that further comprises a sample-presenting surface on which an analyte is presented to the source of ionizing energy. Probes for laser desorption/ionization time-of-flight mass spectrometry are traditionally metallic, either stainless steel, nickel-plated material, or platinum. In use, analyte molecules are mixed with EAMs and embedded within a solid “matrix” on the surface of such a probe prior to the desorption step. In some cases, the probe used for MALDI is in the form of a plate which can have multiple sites, such as wells, for the addition of analyte samples. Alternative methods for the introduction of analytes into the mass spectrometer are also available. See, e.g., U.S. Pat. Nos. 5,719,060, 5,894,063, 6,020,208, and 6,027,942, all of which are incorporated by reference in their entireties. It is intended that the term “probe”, as used herein, include any surface, with or without a predisposed EAM, from which an analyte may be introduced into a mass spectrometer.

### Stability of Calibrant Compositions

According to some embodiments of the invention, the recombinant proteins of the calibrant compositions display improved stability compared to calibrant compositions known in the art. For example, the recombinant proteins may be exchanged into solvents that preserve the solubility of the proteins and that minimize any chemical or physical modifications that could result in changes in the molecular mass or other desirable property of the proteins. In a preferred embodiment, the recombinant proteins are exchanged into such a solvent following their purification. A preferred solvent is 50% formic acid, 25% acetonitrile (“ACN”), 15% isopropanol, and 10% water. Even more preferred solvents are 0.05% trifluoroacetic acid (“TFA”), 0.1% TFA, 0.2% TFA. The proteins are preferably exchanged into the solvent by dialysis, although other methods, for example, solid phase extraction, SEC, electrodialysis, or others, may be used as would be understood by those skilled in the art.

The calibrant compositions of the instant invention are stable when stored at −80° C. In preferred embodiments, the compositions are stable when stored at −20° C. In more preferred embodiments, the compositions are stable when stored at 4° C., 8° C., 12° C., 16° C., 20° C., or even at room temperature. The calibrant compositions of the instant invention may usefully be stable when stored for more than one week, for more than two weeks, or even for more than a month. In preferred embodiments, the calibrant compositions are stable when stored for more than two months, three months, four months, six months, or even longer.

The present invention includes calibrant compositions, such as those described herein, in liquid solution form. The stability of the recombinant protein calibrants disclosed herein allow for shipping and storage of the protein calibrants as liquid solutions. Each recombinant protein of a calibrant set can be provided as a separate solution, or one or more recombinant proteins can be provided in a common solution. The liquid calibrant solutions can optionally comprise one or more matrix additives in addition to one or more recombinant protein calibrants.

### Methods of Calibration

Time-of-flight mass spectrometers may be calibrated by the measurement of time-of-flight values for ions of known mass-to-charge ratios, for example as described in U.S. Patent Application Publication No. 2003/0062473, which is hereby incorporated by reference in its entirety. Values for the accelerating electrical field, the acceleration distance, and distance of the ion drift region are typically constant for a given time-of-flight mass spectrometer, so that

m/z=kt²

where k is constant. A mass spectrometer may thus be calibrated by using calibrant compositions containing molecules that form ions of known mass-to-charge ratios, measuring time-of-flight values for those ions, and determining a value for k, for example by plotting points on a linearized form of the above equation or by curve-fitting on a computer. In a preferred embodiment of the method, the calibrant composition contains recombinant proteins having mass-to-charge ratios close to and flanking the mass-to-charge ratio of an analyte of interest.

A mass spectrometer may be calibrated according to the above method or by other calibration methods using any of the above-described calibrant compositions according to the instant invention. In some embodiments, the mass spectrometer may be calibrated using the calibrant composition as an external standard, by measuring time-of-flight values for the recombinant proteins of the calibrant composition separately from the time-of-flight values for the analyte or analytes of interest. In other embodiments, the mass spectrometer may be calibrated using the calibrant composition as an internal standard, by combining the sample of interest with the calibrant composition and measuring time-of-flight values for the recombinant protein calibrants and the analyte or analytes of interest simultaneously. In still other embodiments, the calibrant composition and the sample of interest may be spotted on the probe separately, but the two spots may be simultaneously, or contemporaneously, ionized and analyzed in time-of-flight measurements. In some embodiments, the mass spectrometer may be calibrated using a single calibrant composition, while in other embodiments, it may be calibrated using a combination of two or more separate calibrant compositions. In these methods, two or more recombinant proteins of a calibrant composition are provided in association with an energy-absorbing molecule and analyzed by MALDI mass spectrometry. The mass spectrometry profiles of the two or more proteins are used to generate a calibration curve of mass by plotting the mass-to-charge ratios of the ionized recombinant proteins against (time of flight)².

As will be clear to one of skill in the art, the methods disclosed and claimed herein may be used to calibrate a mass spectrometer to be used for a wide variety of purposes. For example, the instant methods may be used in calibrating a mass spectrometer used to compare the levels of cellular components, such as proteins, present in samples which differ in some respect from each other, as described in U.S. Pat. Nos. 6,391,649 and 6,642,059, incorporated herein by reference in their entireties. Likewise, the methods may be used in calibrating a mass spectrometer that is used in highly sensitive detection systems, for example the “reporter signal” methods described in U.S. Patent Application Publication No. 2003/0045694, which is incorporated herein by reference in its entirety. The calibration methods thus have advantageous properties which may be used in detection systems in a number of fields, including antibody or protein microarrays, DNA microarrays, expression profiling, identification of biomarkers, comparative genomics, immunology, diagnostic assays, and quality control. Examples of such uses, including protocols and standards useful in the practice of mass spectrometry, may be found in Simpson, Proteins and Proteomics: A Laboratory Manual (2003) and references contained therein, all of which are incorporated herein by reference in their entireties.

### Compositions and Methods for Reducing Laser-Induced Crystal Damage

In other embodiments of the invention, a matrix formulation is used to reduce the level of laser-induced damage to matrix crystals. In order to analyze low-abundance proteins or analytes that ionize inefficiently by laser irradiation, the acquisition time and number of laser pulses must be extended. However, extended analysis of samples in the presence of an energy-absorbing molecule may be impaired by laser-induced crystal damage, typically observed as “flaking” of the crystals.

Accordingly, in these embodiments of the invention, the energy-absorbing molecule is dissolved in a matrix solvent that includes one or more compounds that reduce laser-induced crystal damage and matrix background noise. Use of this matrix solvent significantly improves the signal response of large molecular weight analytes and low-abundance analytes. An additional benefit to matrix stabilization is the ability to repeat analysis of spotted samples archived on a target plate. Furthermore, the matrix solvent may allow a matrix to be stored at 4° C. for 6 months or more.

The present invention thus includes compositions for performing mass spectrometry, where the compositions include at least one energy-absorbing molecule and a matrix buffer formulation that enhances the mass spectrometry profile of the one or more analytes. A matrix buffer formulation can enhance the mass spectrometry profile of an analyte molecule by increasing the intensity of the major peak or peaks of the profile, by reducing the number of satellite peaks or adduct peaks in the profile, or both. In preferred aspects of the invention, a matrix buffer formulation includes an additive that can protect an energy-absorbing molecule crystal from laser-induced damage.

An analyte to be analyzed by mass spectrometry can be any type of molecule, and the molecule can include without limitation, protein, nucleic acid, carbohydrate, lipid, amino acids, nucleobases, nucleosides, or nucleotides, sugars, fatty acids, sterols, or combinations of any of these. An analyte molecule can have additional covalently or noncovalently attached or incorporated organic or inorganic chemical groups or atoms. Preferably, at least one of the one or more molecules that is to be analyzed using mass spectrometry using a matrix buffer formulation has a molecular weight of greater than about 20 kiloDaltons, although this is not a requirement of the present invention. The identity of an analyte can be known or unknown. An analyte can be a molecule of known molecular mass used to calibrate a mass spectrometer, for example, or a molecule whose mass is to be determined. In some preferred aspects of the present invention, the analyte is a protein.

Sinapinic acid, which is mostly used for analysis of intact proteins, has a fragile crystal structure that becomes ablated during prolonged exposure to the MALDI laser. This fragility precludes enhancement of the signal-to-noise of low abundance proteins through longer acquisitions. While protein identification and characterization relies to a great extent on the study of a set of accurate mass measurements derived from proteolytic digests, exact mass measurement of intact proteins still play an important role, especially in the study of post-translational modifications. Sinapinic acid (SA) is generally the matrix of choice for large proteins. However, the acquisition time and number of laser pulses must be extended in order to analyze low-abundant proteins or analytes such as large proteins that ionize inefficiently.

SA crystals appear white and “fluffy” when properly spotted yet, these crystals are quickly depleted by laser irradiation during extended analysis, appearing as “flaking” of the matrix crystals. This laser-induced damage limits the number of scans that can be performed during an analysis. This limitation can impair analysis of low-abundance or large proteins, where averaging over a large number of scans enhances the signal-to-noise.

Other energy-absorbing molecules that can be used for a MALDI matrix and that can be combined with a matrix additive to increase matrix crystal stability include, without limitation, alpha-cyano-4-hydroxycinnmic acid; 2,5 dihydroxybenzoic acid (2,5 DHB); 2-(4-hydroxy-phenol-azo)-benzoic acid (HABA); fucose mixtures with DHB; 2-hydroxy-5-methoxybenzoic acid; 5 methoxysalicylic acid; 2,4,6 trihydroxyacetophenone; 2,6 dihydroxyacetophenone; and 3 hydroxypicolinic acid (HPA).

As used herein a “matrix additive” is a compound for enhancing mass spectrometry of analytes and includes at least one compound that protects an energy-absorbing molecule (EAM) crystal from degradation during laser pulses used for ionization in mass spectrometry. A matrix additive is a compound that can protect an energy-absorbing molecule (EAM) crystal from laser-induced damage during extended or high energy pulses used for ionization of high molecular weight (for example, greater than 90 kilodalton) or low abundance analytes in mass spectrometry.

A matrix buffer formulation preferably includes at least one matrix additive that reduces laser induced matrix crystal degradation. Preferred matrix additives include compounds that structurally resemble the matrix molecule. For example, compounds that include a ring structure can be used as matrix additives for improving mass spectrometry profiles of analytes when pulse intensity, number, or duration is increased. In some preferred embodiments, matrix additives have a morpholino ring (hereinafter described as “morpholino compounds”) or piperazine ring (hereinafter described as “piperazine compounds”). Compounds having morpholino rings are particularly preferred. The morpholine or piperazine ring can have various added groups. A matrix additive of the present invention can be a morpholino compound such as, for example, hydroxyethylmorpholine or N-ethyl morpholine.

The compound can optionally have hydrocarbon chains, such as but not limited to alkanes, alkenes, or alkynes directly or indirectly attached to the morpholino ring. The hydrocarbon chains can optionally have additional chemical groups attached. For example, ethane, propane, or butane groups can attached to the ring structure, such as ethane, propane, or butane sulfonic acid chains or ethane, propane, or butane carboxylic acid chains. In some preferred embodiments of the present invention, a matrix additive for preserving matrix crystal structure is a morpholino compound that comprises a sulfonic acid group, hereinafter referred to as a morpholino sulfonic acid. Preferably the sulfonic acid group is attached to a morpholino ring by a hydrocarbon chain.

Zwitterionic compounds can also be matrix additives for improving mass spectrometry profiles of high molecular weight or low-abundance analytes. Examples of zwitterionic compounds that can be used as matrix additives include glycine, glycylglycine, glycinamide, 2-morpholinoethanesulfonic acid monohydrate (MES), 3-morpholinopropanesulfonic acid (MOPS), 4-N morpholino)butanesulfonic acid (MOBS), 3-N 2-hydroxypropanesulfonic acid (MOPSO)piperazine-1,4-bis(2-ethanesulfonic acid) (PIPES), 4-(2-hydroxyethyl)piperazine-1-ethanesulfonic acid (HEPES), 4-(2-hydroxyethyl)piperazine-1-propanesulfonic acid (HEPPS), N-[tris(hydroxymethyl)methyl]-glycine (Tricine), tris(hydroxymethyl)aminomethane (Tris), N-[tris(hydroxymethyl)methyl]-2-aminoethanesulfonic acid (TES), N-[tris(hydroxymethyl)methyl]-3-aminopropanesulfonic acid (TAPS), N-(2-acetamido)-2-aminoethanesulfonic acid (ACES), N-(2-acetamido)iminodiacetic acid (ADA), N,N-bis(2-hydroxyethyl)-2-aminoethanesulfonic acid (BES), N,N-bis(2-hydroxyethyl)glycine (Bicine), 2-(cyclohexylamino)-1-ethanesulfonic acid (CHES), or 3-(cyclohexylamino)-1-propanesulfonic acid (CAPS).

Zwitterionic compounds that comprise ring structures are preferred, and include for example, zwitterionic compounds that comprise a piperazine or morpholino ring, such as, for example, 2-morpholinoethanesulfonic acid monohydrate (MES), 3-morpholinopropanesulfonic acid (MOPS), 4-N morpholino)butanesulfonic acid (MOBS), 3-N 2-hydroxypropanesulfonic acid (MOPSO), piperazine-1,4-bis(2-ethanesulfonic acid) (PIPES), 4-(2-hydroxyethyl)piperazine-1-ethanesulfonic acid (HEPES), or 4-(2-hydroxyethyl)piperazine-1-propanesulfonic acid (HEPPS).

Zwitterionic compounds comprising a morpholino ring are more preferred, for example morpholino sulfonic acids such as 2-morpholinoethanesulfonic acid monohydrate (MES), 3-morpholinopropanesulfonic acid (MOPS), 4-N morpholino)butanesulfonic acid (MOBS), or 3-N 2-hydroxypropanesulfonic acid (MOPSO). Examples 1, 2 and 3 illustrate the enhancement effect of two zwitterionic morpholino sulfonic acid compounds, MES and MOPs, on the mass spectrum of high molecular weight proteins. The invention includes derivatives of these compounds, including compounds having added or substituted groups, differences in chain length or hydrogenation, or other variations that do not deviate from the overall structure of the named compounds.

Compounds, such as those belonging to the groups delineated above, can be tested for their suitability as matrix crystal protectants and their ability to improve the signal-to-noise ratio of mass spectra, by using the compounds in MALDI mass spectrometry experiments that assess crystal damage with increased laser shots, and MALDI spectra of proteins (such as proteins subjected to extended laser pulses) in the presence and absence of the additive. Examples of such tests are provided in Examples 2 and 3.

The concentration of a matrix additive in a composition for mass spectrometry (that is, a composition that comprises an analyte, matrix molecule, and matrix formulation as provided on a probe for analysis) is not limiting. The concentration can be from about 5 millimolar to about 500 millimolar, and is preferably from about 10 millimolar to about 200 millimolar, and more preferably yet between about 20 millimolar and about 100 millimolar.

A composition for mass spectrometry analysis of one or more analytes can also include other components, such as, but not limited to, ions, salts, acids, or bases. Such components can enhance the protective effects of a component that preserves crystal structure or can improve the condition or structure of analytes within the EAM crystal. For example, some proteins can form aggregates that are detrimental to mass spectrometry analysis. Providing one or more ions, salts, or compounds that can prevent protein aggregation can improve the mass spectrometry profile of such proteins. For example, in some preferred embodiments, a matrix buffer formulation can include an organic ion (such as acetate) or a trivalent anion, such as, for example phosphate, diphosphoglycerate, or a tricarboxylic acid such as citrate, aconitic acid, or 1-carboxyglutamic acid, any of which can be provided as a salt. For example an ammonium salt of a tricarboxylic acid such as ammonium citrate can be used.

In using ions or salts along with a matrix additive, certain ions or salts can be less preferred, depending on the analyte. These include metal ions or salts (excepting circumstances in which the binding of metal to an analyte is desirable).

In some preferred embodiments, a matrix formulation includes ammonium citrate at a concentration of from about 1 millimolar to about 100 millimolar in the mass spectrometry sample on the MALDI plate, more preferably at a concentration of from about 2 millimolar to about 50 millimolar, and more preferably yet at a concentration of from about 4 millimolar to about 25 millimolar. For example, some preferred matrix buffer formulations include ammonium citrate in the mass spectrometry sample on the MALDI plate at a concentration of 5 millimolar or 10 millimolar.

The present invention thus includes compositions for performing mass spectrometry, where the compositions include one or more analytes whose molecular mass is to be determined using mass spectrometry, at least one energy-absorbing molecule, and a matrix buffer formulation that enhances the mass spectrometry profile of the one or more analytes. In preferred aspects of the invention, the analyte is a protein. A matrix buffer formulation can enhance the mass spectrometry profile of an analyte molecule by increasing the intensity of the major peak or peaks of the profile, by reducing the number of satellite peaks or adduct peaks in the profile, or both, particularly in the case of high molecular weight or low abundance proteins or protein variants. Preferred matrix buffer formulations include those that contain additives disclosed herein, such as zwitterionic compounds comprising a ring structure.

The present invention includes compositions that includes one or more mass spectrometry protein calibrants, an energy-absorbing molecule (EAM), and a matrix buffer formulation, where the matrix buffer formulation is a compound that improves the mass spectrometry profile of the one or more mass spectrometry protein calibrants.

The present invention also includes compositions that includes two or more mass spectrometry protein calibrants, an energy-absorbing molecule (EAM), and a matrix buffer formulation, where the matrix buffer formulation is a compound that improves the mass spectrometry profile of the one or more mass spectrometry protein calibrants.

The matrix buffer formulation can be a solution in which one or more of the protein calibrants is also provided, or can be a solution or solid compound provided separately, or can be in a solution in which an energy-absorbing molecule (EAM) is provided. For example, any of the protein calibrants described herein can include one or more compounds that improve the mass spectrometry profile of one or more of the calibrants by reducing EAM crystal fragmentation. Preferred matrix buffer formulations are those containing additives that are zwitterionic compounds, particularly zwitterionic compounds that contain a ring structure. In some preferred embodiments, a matrix additive is a morpholino sulfonic acid such as MES, MOPS, MOPSO, or MOBS.

The exact composition of a matrix buffer formulation can be optimized for a particular protein calibrant. For example, the mass spectrum of a particular protein may show an increased signal-to-noise ratio using a particular concentration of a matrix buffer formulation component. Similarly, compounds such as but not limited to ammonium citrate may improve the spectrum of particular analytes. Mass spectrometry can be performed on one or more analytes of interests in the presence or absence of a compound, or in the presence of a compound at several concentrations, to optimize the mass spectrum of the analyte.

The matrix buffer formulation can be a solution in which one or more of the protein calibrants is also provided, or can be a solution or solid compound provided separately, or can be in a solution in which an energy-absorbing molecule (EAM) is provided. For example, any of the protein calibrants described herein can include one or more compounds that improve the mass spectrometry profile of one or more of the calibrants by reducing EAM crystal fragmentation.

One or more components of a matrix buffer formulation can be made up as a solution and added to a solution of an EAM. A protein calibrant can be added to the matrix buffer formulation plus EAM before applying the calibrant to the probe, or the calibrant solution and matrix buffer formulation plus EAM can be added separately to the same location of a probe (such as, for example, the same well of a MALDI plate) separately. In an alternative, one or more components of a matrix additive can be made up as a solution and used to resuspend a calibrant, or can be added to a calibrant solution. A calibrant plus matrix additive solution can be added to the EAM either before applying the calibrant to the probe or the calibrant/matrix buffer formulation and EAM can be added to the same location of a probe (such as, for example, the same well of a MALDI plate) separately. A third alternative it to apply calibrant solution, EAM, and matrix additive separately to the same location on a probe (such as the same well of a MALDI plate)

In a preferred embodiment, the energy-absorbing molecule is sinapinic acid. In a highly preferred embodiment, the matrix buffer formulation contains MES buffer. In another highly preferred embodiment, the matrix buffer formulation contains ammonium citrate. In another highly preferred embodiment, the matrix buffer contains both MES buffer and ammonium citrate.

Preferably, at least one of the one or more proteins to which a matrix buffer formulation is added has a molecular weight of greater than about 20 kDa, more preferably greater than about 70 kDa, and yet more preferably greater than about 90 kDa. The matrix formulation includes at least one compound that prevents EAM crystal fragmentation, such as, for example, a zwitterionic morpholino compound such as, but not limited to, those described herein.

Preferably, the two or more proteins whose molecular mass is known are mass spectrometry calibrants of the present invention. Protein calibrants can be used as internal or external calibration standards.

The invention includes methods of calibrating a mass spectrometer using mass calibrants, such as, but not limited to, the mass spectrometry calibrants described herein. The method includes: providing two or more proteins whose molecular mass is known, adding to the two or more proteins an EAM, adding to one or more of the two or more proteins a matrix buffer formulation of the present invention, and using a mass spectrometer to perform MALDI on the two or more proteins to calibrate the mass spectrometer.

The invention also includes a method of detecting a post-translational modification of a test protein, by providing a calibrant composition of the present invention that comprises a plurality of recombinant proteins spanning a predefined molecular mass range and separated by one or more molecular mass increments; and an energy-absorbing molecule, where the method includes applying two or more of the recombinant proteins and the energy-absorbing molecule to a mass spectrometer probe, using the mass spectrometer to perform mass spectrometry on the two or more recombinant proteins to obtain a mass spectrometry profile of at least two of the recombinant proteins to calibrate the mass spectrometer, performing mass spectrometry on a sample to obtain a mass spectrometry profile of one or more proteins of the sample, or fragments thereof, and analyzing the mass spectrometry profile of the one or more proteins of the sample, or fragments thereof, to determine the molecular weight of the one or more proteins of the sample, or fragments thereof, in which a change in molecular weight of a protein, or fragment thereof, of the one or more proteins of the sample, compared to the predicted molecular weight of the protein, or fragment thereof, is indicative of a post-translational modification of the protein.

In these aspects, the calibration of the mass spectrometer using the calibrants can be advantageous for determining precise molecular weight of post-translationally modified proteins. Matrix additives, such as those disclosed herein, can be added to one or more calibrants, one or more sample proteins, or both, to determine mass of proteins of high molecular weight or low abundance using mass spectrometry.

### Kits

In some embodiments, the calibrant compositions of the instant invention are prepared as solutions to be used in kits and methods for the calibration of mass spectrometers. Preferably, such solutions are provided “ready to go”, i.e., they can be used directly in mass spectrometers without further manipulation. Alternatively, a stock solution or solid material may be provided that may be diluted or dissolved to prepare a calibration solution. Moreover, the components of the calibrant composition may be provided in separate containers that are mixed together in order to prepare one or more calibration solutions.

The stability of the recombinant protein calibrants disclosed herein allow for shipping and storage of the protein calibrants as liquid solutions in kits. Each recombinant protein of a calibrant kit can be provided as a separate solution, or one or more recombinant proteins can be provided in a common solution. The liquid calibrant solutions can optionally comprise one or more matrix additives in addition to one or more recombinant protein calibrants.

The present invention also includes methods of generating revenue comprising selling liquid mass spectrometry calibrants and shipping the liquid mass spectrometry calibrants to a customer. The method includes sale and shipment of recombinant proteins mass spectrometry calibrants disclosed herein, such as those comprising at least two recombinant proteins.

One or more of the recombinant proteins can be formulated with a zwitterionic compound, such as, for example, a morphalino-containing zwitterionic compound. The recombinant proteins can be pre-mixed with a matrix buffer formulation or an EAM, or both.

The present invention includes methods in which the recombinant protein calibrants are produced, purified, and solubilized or formulated to provide one or more stable solutions each comprising one or more recombinant protein calibrants, where the concentration of the calibrants can be a concentration for direct use, or intended for dilution. The production, purification, and formulation as a solution for use by a customer is by a party other than the user, or customer, of the calibrants, and at a location other than that of its use as a calibrant in mass spectrometry. Preferably, the recombinant protein calibrants are shipped as a liquid solution in frozen form, but this is not a requirement. In other embodiments, the recombinant protein calibrants are shipped as a liquid solution on ice or a cold pack. Shipment can be by air, train, automobile, van, or truck.

The customer or purchaser of the liquid calibrants can provide cash, cash equivalents, services, or other products in exchange for the recombinant protein calibrants.

In some embodiments of the kits of the instant invention, an EAM is provided together with protein calibrants. In preferred embodiments, the EAM is a cinnamic acid derivative. In even more preferred embodiments, the EAM is sinapinic acid, alpha-cyano-4-hydroxycinnmic acid; or 2,5 dihydroxybenzoic acid (2,5 DHB). Other matrix molecules that can be provided in a kit include 2-(4-hydroxy-phenol-azo)-benzoic acid (HABA); fucose mixtures with DHB; 2-hydroxy-5-methoxybenzoic acid; 5 methoxysalicylic acid; 2,4,6 trihydroxyacetophenone; 2,6 dihydroxyacetophenone; and 3 hydroxypicolinic acid (HPA). In some embodiments of the invention, the EAM is pre-mixed with the protein calibrants, while in other cases, the EAM or EAMs is provided separately. In some kit embodiments, the EAM is predisposed on the probe itself.

Some of the kit embodiments of the instant invention further comprise solvents useful for the dilution of the protein calibrants. Preferred solvents for use in the kits of the invention include TFA and ACN. In even more preferred embodiments, the aqueous solvents of the kits use sodium-free water. In other even more preferred embodiments, the ACN is HPLC- or pesticide-grade.

In some preferred embodiments of the present invention, kits include at least one matrix additive for enhancing the mass spectrum of an analyte. For example, a kit can comprise a solution of a matrix additive such as a compound that includes a morpholino ring or a zwitterionic compound. In some preferred embodiments, a zwitterionic compound is a matrix additive provided with protein calibrants. For example, a solution of a zwitterionic morpholino compound, such as but not limited to those disclosed herein, can be provided in a kit to improve the signal-to-noise ratio in a mass spectrum of one or more of the protein calibrants provided in the kit.

A matrix additive can be provided as a separate solution to be added to the EAM or to a protein calibrant. In an alternative, one or more protein calibrants of the kit can be provided in a solution that contains a matrix additive.

In another alternative, a matrix additive can be provided in an EAM solution, and the one or more protein calibrants can be provided separately.

The present invention also includes kits that contain an EAM solution that contains a matrix additive, such as but not limited to a zwitterionic morpholino compound, that can be used to improve the signal-to-noise ratio in a mass spectrum of one or more analytes not provided in the kit.

Compounds other than zwitterionic compounds such as morpholino-sulfonic acids that can enhance the mass spectrometry profile of a protein can be provided in solution with a morpholino-sulfonic acid compound, or separately. For example, a compound, acid, base, or salt (such as, for example, ammonium citrate) that enhances solubility or structural integrity of one or more protein calibrants can be provided in a protein calibrant solution, as a separate solution or solid in a tube or vial, or in a morpholino-sulfonic acid solution.

Liquid components of kits are stored in containers, which are typically resealable. A preferred container is a capped plastic tube, particularly a 1.5 ml capped plastic tube. A variety of caps may be used with the liquid container. Generally preferred are tubes with screw caps having an ethylene propylene O-ring for a positive leak-proof seal. A preferred cap uniformly compresses the O-ring on the beveled seat of the tube edge. Preferably, the containers and caps may be autoclaved and used over a wide range of temperatures (e.g., +120° C. to −200° C.) including in use with liquid nitrogen. Other containers may be used. Generally, opaque containers are preferred.

In some embodiments of the invention, the kits include instructions for mixing the separately-provided recombinant proteins to create a calibrant composition having desired properties. In preferred embodiments, the instructions will provide mixing ratios for every two proteins, so that calibrant compositions with any desired range may be prepared.

In some embodiments of the invention, the kits include instructions for mixing the separately-provided matrix buffer formulation with an EAM solution to create a composition for mass spectrometry analysis.

In some embodiments of the invention, the kits include instructions for mixing the separately-provided matrix buffer formulation with a protein solution to create a composition for mass spectrometry analysis.

Kits of the invention may in some embodiments further comprise one or more reference spectra showing one or more images of the calibrant compositions after they have been subjected to mass spectrometry. Typically, such spectra will indicate a value, such as the molecular mass, for each protein calibrant. The reference spectra may be provided individually for each protein calibrant, or spectra showing the analysis of mixtures of two or more of the protein calibrants may be provided.

In some embodiments, kits of the invention may further comprise mass spectrometric probes. In some embodiments, the probe may include a predisposed EAM, so that a calibrant protein solution may be added directly to the probe without the separate addition of such molecule.

It will be readily apparent to one of ordinary skill in the relevant arts that other suitable modifications and adaptations to the methods and applications described herein may be made without departing from the scope of the invention or any embodiment thereof. Having now described the present invention in detail, the same will be more clearly understood by reference to the following Example, which is included herewith for purposes of illustration only and is not intended to be limiting of the invention.

### Example 1

### Production and Characterization of High Molecular Weight Recombinant Protein Calibrants For Mass Spectrometry

The general methods used in expressing the recombinant protein calibrants of this example may be found in PCT International Publication No. WO98/30684, which is incorporated herein by reference in its entirety.

### Protein Purification

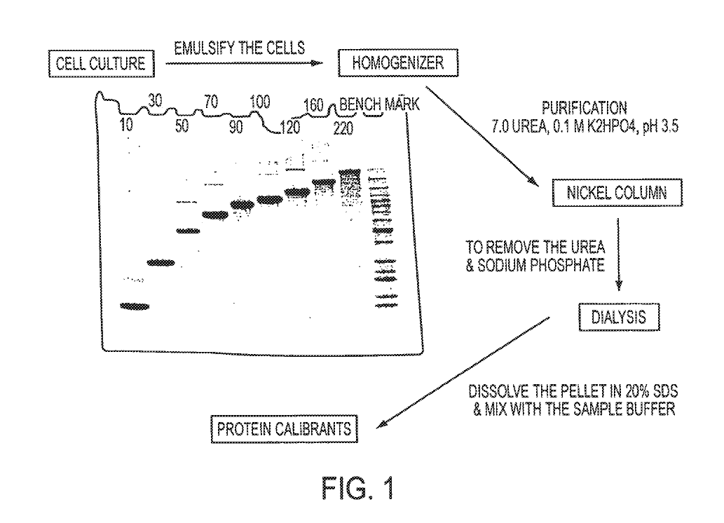

In general, the sensitivity of mass spectrometry is much higher than that of gel electrophoresis with visible stains, and many more background impurities may therefore be detected. Such impurities may, in some circumstances, interfere with a mass spectrometric analysis. For example, FIG. 1 shows the background impurities observed on overloaded gels in the individual proteins comprising the BenchMark™ Protein Ladder. The proteins were eluted from a nickel column, dialyzed against water, and the resulting precipitate was redissolved in 2% SDS. The proteins were run on a 4-20% Tris-glycine gel.

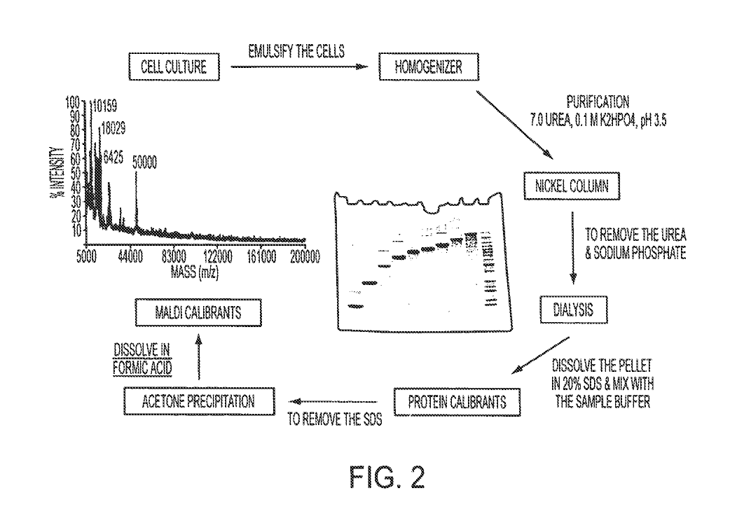

To analyze the above samples by mass spectrometry, the SDS was first removed by extraction of the protein solutions using ethanol or acetone. The resulting protein precipitates were then dissolved in a solution suitable for mass spectrometry (50% formic acid, 25% ACN, 15% isopropanol, and 10% water; see Herbert et al. (2001) Electrophoresis 22:2046-2057). MALDI spectra were obtained from these precipitates to determine molecular weights and to assess the suitability of the proteins for use as MALDI calibration standards. The protocol yields proteins displaying spectra that were contaminant free for all but the 50 kDa protein (FIG. 2).

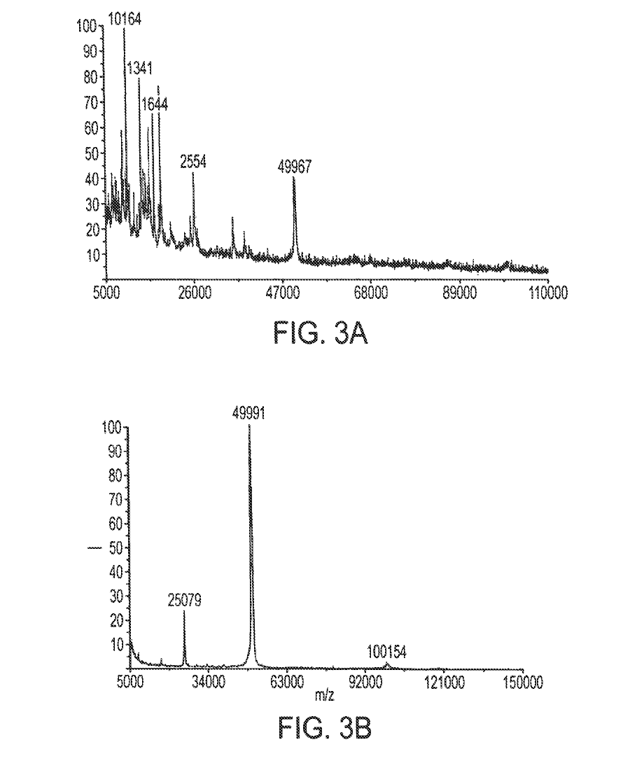

Purification of the 50-kDa protein using this method (acetone precipitation followed by dissolving in a mass spectrometry compatible solvent) resulted in a protein mixture consisting of a large number of impurities (FIG. 3a), which caused the suppression of the 50-kDa peak. This protein was subjected to further purification using SEC (column: BioSep-SEC-S3000, 300×7.8 mm, PN-00H2146-KO, Phenomenex, mobile phase buffer: phosphate buffer saline, PBS). A solution of the 50-kDa solution in 2% SDS was diluted 1:2 with water before injection into the column. A fraction containing the 50-kDa protein after SEC purification was subjected to MALDI MS analysis (FIG. 3b). This sample shows a significant improvement over the sample prior to SEC purification.

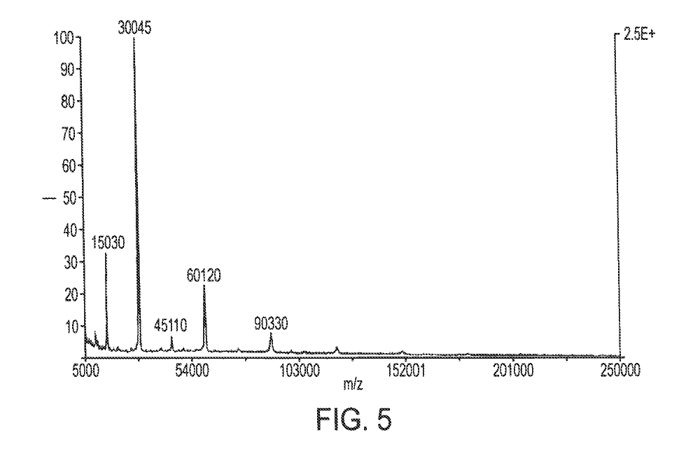

Proteins purified by acetone precipitation have been shown to be suitable for use as mass spectrometry standards. For example, FIG. 4 illustrates calibration using a mixture of Phosphorylase B (MW: 97,200.1 Da) and the 90-kDa protein. The signal intensity of the 90-kDa protein is comparable to that of Phosphorylase B, which is typically used as a MALDI standard in this mass region (solvent: 0.1% TFA). The 90-kDa protein further shows superior resolution to that of Phosphorylase B: 119 and 97, respectively. Other solvent systems may also be suitable for reconstituting the precipitated calibrant proteins. For example, 0.1% TFA works well with smaller proteins such as the 30-kDa protein (FIG. 5).

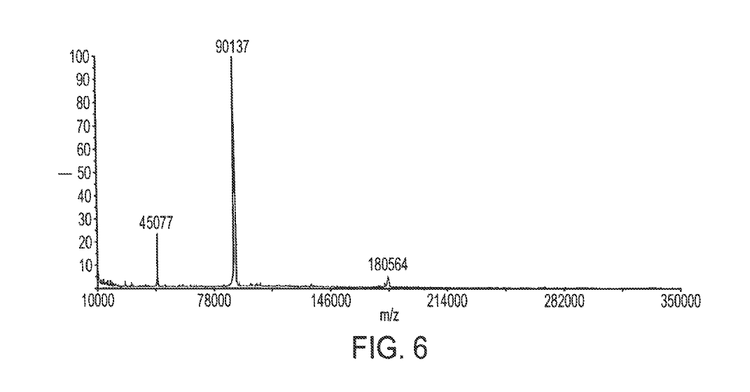

FIG. 6 shows a MALDI spectrum of the 90-kDa protein that had been acetone precipitated, dissolved in 50% formic acid, 25% ACN, 15% isopropanol, and 10% water, and diluted 1:1 with a MES buffer. Sinapinic acid (“SA”) was used as the energy-absorbing molecule in the matrix. The spectrum demonstrates a lack of impurities and a high resolution of the protein peaks.

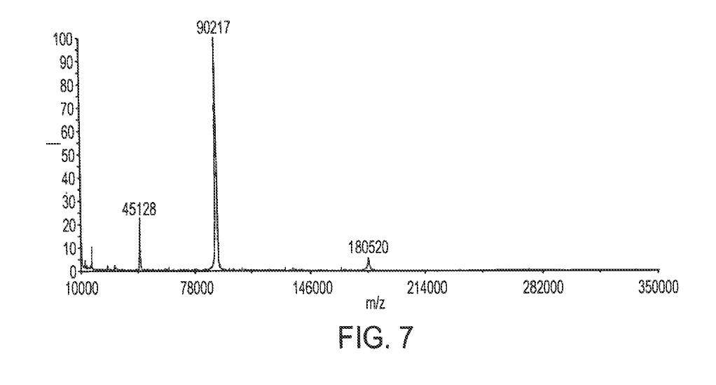

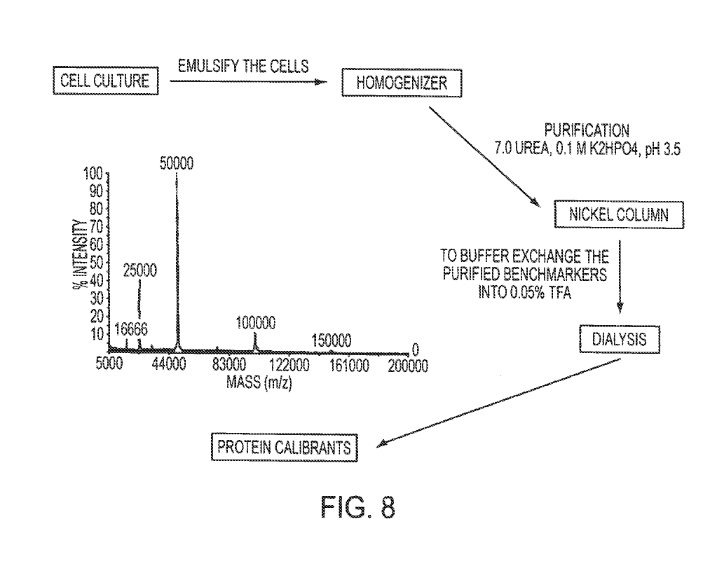

The purification procedure may be improved by directly dialyzing samples obtained from the nickel column against 0.05% or 0.1% TFA. FIG. 7 shows a mass spectrum obtained with the 90-kDa protein, dialyzed against 0.1% TFA using the drop dialysis method. Similar results were obtained using both cassette dialysis and counter current dialysis. The protocol is summarized in FIG. 8.

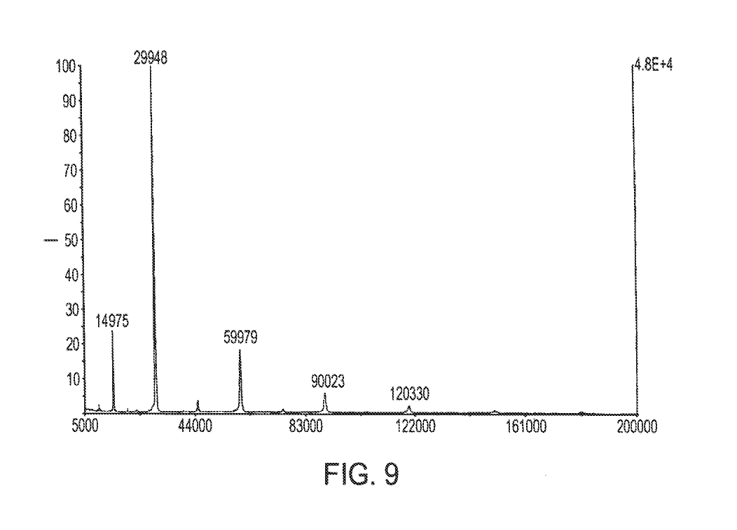

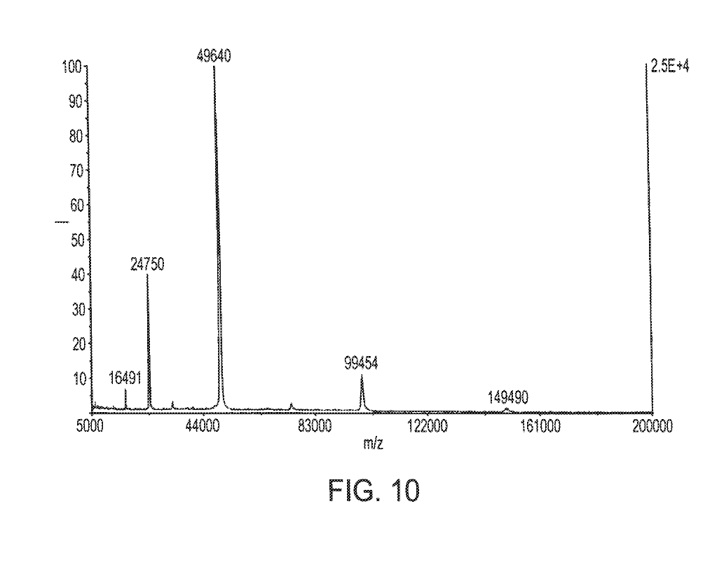

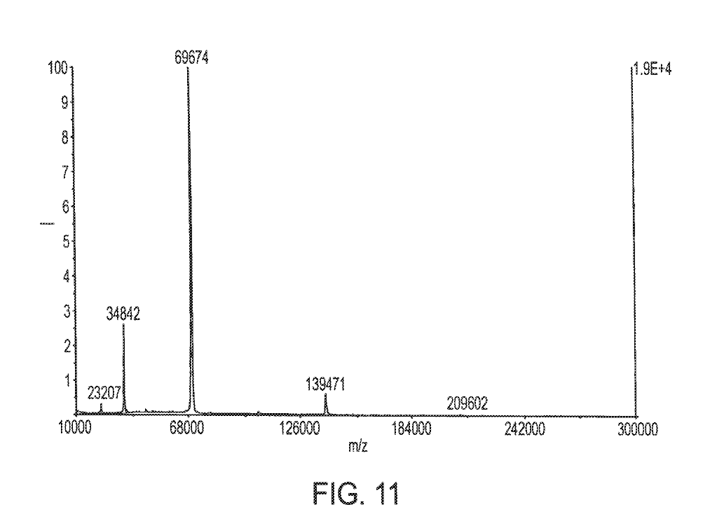

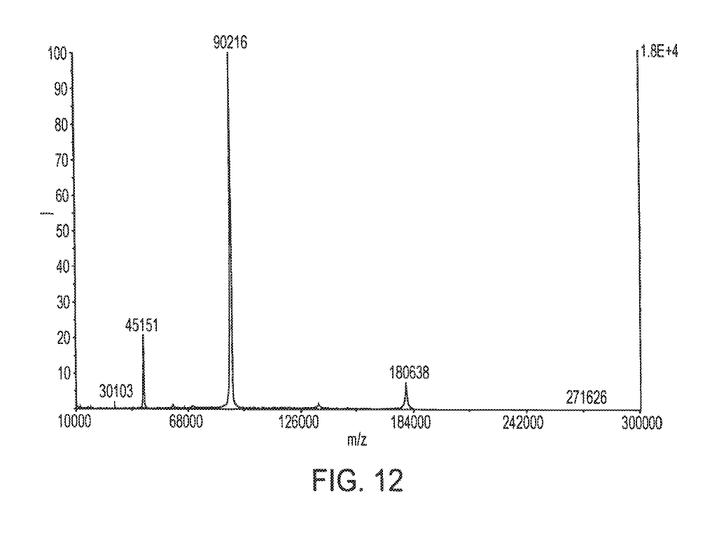

The purification procedure may still further be improved by using mass spectroscopy to assess the purity of fractions eluting from the nickel column. As shown in Table 2, the purity of each protein calibrant may be judged qualitatively by examination of the resulting mass spectra for each fraction. Example spectra for the highest purity fractions are shown for the 30-kDa protein, the 50-kDa protein, the 70-kDa protein, and the 90-kDa protein in FIGS. 9-12. Parameters used to acquire the mass spectra are shown in Table 1.

TABLE 1
Instrumental parameters used on the VOYAGER-DE-STR for acquisition of the Calibrants MALDI spectra.

| | Calibrants | | | | |
|---|---|---|---|---|---|
| VOYAGER-DE-STR | Cal 30-kDa | Cal 50-kDa | Cal 70-kDa | Cal 90-kDa | Cal 160-kDa |
| Method File | Linear_60000.bic | Linear_60000.bic | Linear_60000.bic | Linear_150000.bic | Linear_150000.bic |
| Laser Intensity* | 2023 | 2023 | 2023 | 2133 | 2133 |
| (arb. units) | | | | | |
| Delay (ns) | 700 | 700 | 700 | 1500 | 1500 |
| Accelerating | 25 | 25 | 25 | 25 | 25 |
| Voltage (kV) | | | | | |
| Grid Voltage (%) | 90 | 90 | 90 | 90 | 90 |
| Bin Size (nsec) | 4 | 4 | 4 | 10 | 10 |
| Bandwidth (MHz) | 25 | 25 | 25 | 25 | 25 |
| Matrix | SA | SA | SA | SA | SA |

*Laser intensity can depend on a number of parameters and vary up to ±100 units. Since the laser energy decreases by time, the laser intensity may need to be increased over time.

TABLE 2
Quality of purification fractions tested by MALDI-MS.
Nickel Column Purification

| Calibrant | | | |
|---|---|---|---|
| protein | Fraction | Quality (MS)* | Concentration** |
| 30-kDa | 3 | Good | Very Low |
| | 4 | Good | High |
| | 5 | Good | High |
| | 6 | OK | High |
| | 7 | Best | Highest |
| | 8 | Very Good | High |
| | 9 | Good | Very Low |
| 50-kDa | 3 | OK | Very Low |
| | 4 | Good | High |
| | 5 | Good | High |
| | 6 | Good | High |
| | 7 | Best | Highest |
| | 8 | Very Good | High |
| | 9 | Very Good | High |
| | 10 | Very Good | High |
| 70-kDa | 3 | Good | Low |
| | 4 | Good | High |
| | 5 | Good | High |
| | 6 | Good | High |
| | 7 | Best | Highest |
| | 8 | Very Good | High |
| | 9 | Very Good | High |
| | 10 | Very Good | High |
| 90-kDa | 3 | Good | Very Low |
| | 4 | Good | High |
| | 5 | Good | High |
| | 6 | Good | High |
| | 7 | Best | Highest |
| | 8 | Very Good | High |
| 160-kDa | Count. Flow Tube gel | Excellent | see text |

*MS quality was judged based on purity of the spectrum and S/N ratio.
**Concentration based on MALDI signal intensity. Samples were also analyzed by BCA assay.

The nickel column chromatography is performed as follows.

### Materials:

### Column: 100 mL, Pharmacia

### Packing Material ToyoPearl 650, TosoHaas

### Lysis Buffer: 50 mM Tris-HCl, 2 mM Magnesium Chloride, pH 8.0

### Purification Buffers:

### 100 mM Sodium Phosphate, 7M Urea, 4 mM Imidazole, pH 8.0

### 100 mM Sodium Phosphate, 7M Urea, pH 3.5

### 50 mM EDTA

### 0.1N NaOH

### 1M Nickel Sulfate

The column is packed by ToyoPearl 650 beads using water at a flow rate of 65 mL/min. The measured final volume of the packed column is 70 mL. The column is charged and prepared for the purification process by adding 160 mL of 1M Nickel Sulfate at a flow rate of 20 mL/min followed by 240 mL of water to wash the excess Nickel Sulfate. The final step to prepare the column is to wash and equilibrate with 320 mL of 100 mM Sodium Phosphate, 7M Urea, 4 mM Imidazole, at pH 8.0.

Between 5.0-6.0 g of cells are resuspended in 50 mL of lysis buffer. The resuspended cells are lysed using a Homogenizer instrument. The lysed cells are centrifuged for 30 minutes at 5000×g. The supernatant containing DNA, RNA and all other unwanted cell parts is decanted. The pellet is resuspended in 50 mL of water and centrifuged for 30 minutes at 5000×g to wash, twice. The washed pellet is completely dissolved in 100 mM Sodium Phosphate, 7M Urea, 4 mM Imidazole, pH 8.0. The mixture then is centrifuged for 45 minutes at 5000×g.

The proteins, dissolved in 100 mM Sodium Phosphate, 7M Urea, 4 mM Imidazole, pH 8.0, are injected into the charged and equilibrated column. The (His)₆-tagged protein markers bind to the charged beads and the unwanted proteins are washed off by adding 600 mL of 100 mM Sodium Phosphate, 7M Urea, 4 mM Imidazole (pH 8.0) at flow rate 20 mL/min. The (His)₆-tagged proteins are eluted using 600 mL of 100 mM Sodium Phosphate, 7M Urea, pH 3.5 and are collected using a fraction collector set at 1 minute (˜20 mL) per fraction. The fractions containing the calibrant proteins are identified based on detected peaks from the chromatogram.

The quality of the purification is tested by analyzing each collected fraction using MALDI-MS. Results are tabulated in Table 2. For the 30, 50, 70, and 90 kDa proteins, fraction 7 provided excellent MALDI mass spectrometry results (FIGS. 9-12). Both the purity (absence of any other protein peaks in the spectrum) and the concentration (all protein samples gave peak intensities of higher than 1.0E+4) demonstrate the usefulness of the purified proteins as mass calibrants.

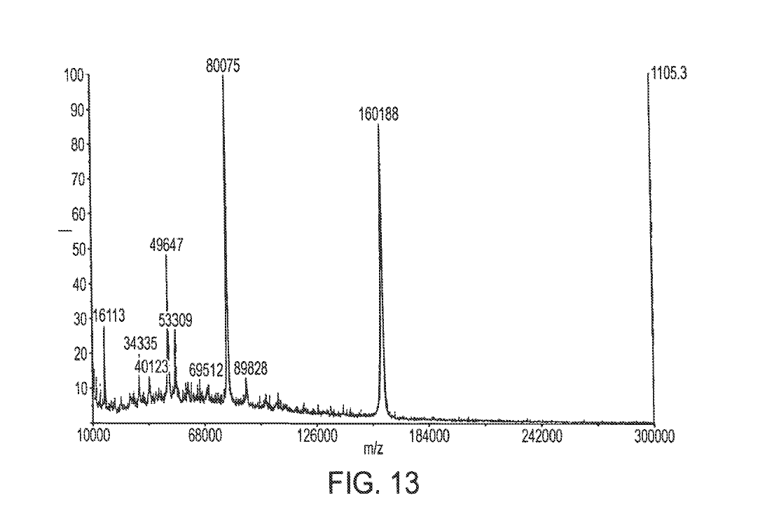

The mass spectrum of the 160-kDa protein as fractionated on the nickel column indicated the presence of impurities, a relatively low protein concentration, and a resulting suppression of protein ionization (FIG. 13). This protein was purified using a modified protocol, including the use of a large-volume, continuous flow IEF tube gel, as described below.

About 5 g of bacterial cell pellets are resuspended in 40 ml of BugBuster HT (Novagen) plus 40 mg of lysozyme and are incubated on ice for about 30 min. Ten ml of detergent buffer (5×) containing 250 mM Tris (pH8.0), 2.5 M NaCl, 0.5% SDS, 2.5% sodium deoxycholate, 5% Triton X-100, and 5 mM PMSF are added to the cell suspension. The cell suspension is passed through a 60 ml syringe with a 16-gauge needle three times and then centrifuged at 15,000 rpm for 20 min using 30 ml centrifuge tubes. The supernatant is discarded. The pellets are resuspended in 40 ml of BugBuster HT again and the above procedure is repeated.

The final pellets are dissolved in 30 ml of column buffer A (100 mM Sodium Phosphate, 7 M Urea, 10 mM Imidazole, pH 8.0) and centrifuged at 15,000 rpm for 15 min. The supernatant is loaded on a 50 ml ToyoPearl 650 column precharged with NiSO₄ and pre-equilibrated with buffer A. The column is washed with 400 ml column buffer and then eluted with 200 ml buffer B (100 mM Sodium Phosphate, 7M Urea, pH 3.5). The eluent is transferred to a 10,000 Da molecular weight cut off dialysis tube and dialyzed overnight in 4 liter of H₂O. Protein precipitate is harvested via centrifugation at 10,000 rpm and stored at −80° C.

The pellets are dissolved in 6 ml of 1×SDS sample buffer containing 50 mM DTT. Half of the sample is loaded onto a tube gel (Model 491 Prep Cell) cast with 4.2% Acrylamide (Tris-Gly SDS-PAGE). The flow rate is set at 220 rpm, which is about 1 ml/min. After a 7 hour lag, fractions of 2.5 ml each are collected. Samples (30 μl) are taken from selected fractions and run on SDS-PAGE to determine the elution pattern. Fractions with pure p160 protein are combined and concentrated with a 15 ml centrifugal filter device having a 10,000 Da molecular weight cut off (Millipore). The concentrated protein is precipitated overnight with a final concentration of 80% acetone at −20° C. After centrifugation at 14,000 rpm, pellets are washed once with acetone, twice with isopropanol, and dried with a speed vac. Purified p160 protein is stored at −80° C. It is dissolved in 0.2% TFA prior to use.

### DNA Sequencing

Amino acid sequences of the expressed proteins were confirmed by sequencing plasmids purified from the E. coli cells used to express the proteins. Plasmids are purified using the QIAGEN, QIAprep Spin Miniprep Kit (Catalog No. 27104) using the following steps:
1. 40˜60 μg of the cells pellets are resuspended by adding 250 μl of P1+ Rnase A and vortexed to completely dissolve the pellet.
2. A 250 μl aliquot of lysing buffer (P2) is added to the cell pellets and mixed gently by inverting the tube 5-6 times. The sample is then incubated for 3-4 minutes (no more than 5 minutes) at RT (should become slightly clear). P2 contains NaOH and SDS.
3. A 350 μl aliquot of neutralizing buffer N3 (containing guanidine hydrochloride and acetic acid) is added to adjust the pH and inverted gently 4-5 times.
4. 40˜60 μg of the cells pellets are resuspended by adding 250 μl of P1+ Rnase A and vortexed to completely dissolve the pellet.
5. A 250 μl aliquot of lysing buffer (P2) is added to the cell pellets and mixed gently by inverting the tube 5-6 times. The sample is then incubated for 3-4 minutes (no more than 5 minutes) at RT (should become slightly clear). P2 contains NaOH and SDS.
6. A 350 μl aliquot of neutralizing buffer N3 (containing guanidine hydrochloride and acetic acid) is added to adjust the pH and inverted gently 4-5 times.
7. The sample is centrifuged at 14000 rpm for 5 minutes.
8. The supernatant is transferred to a mini column and spun for 14000 rpm for 1 minute and discarded.
9. A 500 μl aliquot of PB buffer (containing guanidine hydrochloride and isopropanol) is added to the column, spun at 14000 rpm for 1 minute and the supernatant is discarded. This procedure is repeated by adding 750 μl of PE.
10. Sample is dried by spinning another minute at 14000 rpm (ethanol is removed).
11. The column is transferred to a new tube after adding 50 μl of UPW, spun, and collected.
12.

The purity of the plasmids were checked and the sequences of the protein-encoding regions determined by standard methods. Protein sequences were obtained from the nucleotide sequence using the TRANSLATE Tool (ExPASy).

### 10 kD Protein (MWₐᵥₑ: 10,171.6)

For the production of the 10 kD protein, a 10 kD fragment of thioredoxin was used, with the deletion of −2 kD portion from the carboxy terminus. See PCT International Publication No. WO98/30684. Sequencing of the 10 kD plasmid showed that the construct used contained amino acids 1-85 from thioredoxin and six histidine residues (with a disulfide bond between Cys residues 32 and 35). The N-terminal methionine is cleaved. The protein has the following sequence:

(SEQ ID NO: 1)
SDKIIHLTDDSFDTDVLKADGAILVDFWAEWCGPCKMIAPILDEIA
DEYQGKLTVAKLNIDQNPGTAPKYGIRGIPTLLLFKNGEHHHHHH

Mass spectrometric data confirmed the above sequence; internal calibration provided a mass of 10,169.4 Da for the [M+H]⁺ ion (error of less than 0.005%, but accounted for by the internal disulfide bond). The presence of a disulfide bond was verified by oxidation to cysteinic acid and subsequent digestion.

For higher molecular weight proteins, a vector was developed, ptrxA-concat, to make fusion proteins. See PCT International Publication No. WO98/30684, FIG. 4. This vector encodes the following amino acid sequence:

(SEQ ID NO: 2)
MSDKIIHLTDDSFDTDVLKADGAILVDFWAEWCGPCKMIAPILDEI
ADEYQGKLTVAKLNIDQNPGTAPKYGIRG

The series of higher molecular weight proteins are made by linking this vector to single or multiple fragments of thioredoxin, DEAD-box protein, KpnI methylase, and/or modified T4 gene 32 protein. See Tables 3 and 4, below.

### 20 kD Protein (MWₐᵥₑ: 19,891.5)

The 20 kD protein consists of the fragments of Thioredoxin+5 kD Dead-box+5 kD Dead-box and has the following amino acid sequence:

(SEQ ID NO: 3)
SDKIIHLTDDSFDTDVLKADGAILVDFWAEWCGPCKMIAPILDEIA
DEYQGKLTVAKLNIDQNPGTAPKYGIRGGLGKLTNPEVELPNAELL
GKRRLEKFAAKVQQQLESSDLDQYRALLGKLTNPEVELPNAELLGK
RRLEKFAAKVQQQLESSDLDQYRALLGYNTDNKHHHHHH

Amino acids 2-75 correspond to the ptrxA-concat, above, while the underlined sections of the above protein sequence (5 kD) correspond to the protein sequence of DEAD-box protein (see PCT International Publication No. WO98/30684, FIG. 6):

(SEQ ID NO: 4)
KLTNPEVELPNAELLGKRRLEKFAAKVQQQLESSDLDQYRALL

A portion of the above sequence plus the last 13 amino acids including the 6×His tag (165-177) correspond to a 5 kD protein, the coding sequence for which can be amplified by PCR from the DEADBOX gene:

(SEQ ID NO: 5)
MKRRLEKFAAKVQQQLESSDLDQYRALLGYNTDNKHHHHHH

Mass spectrometric data for the 20 kD protein provided a molecular weight of 19,895 Da for the [M+H]⁺ ion; a value that represents an error of <0.01%. The amino acids shown in italics in the 20 kD protein sequence, GLG and G, provide connections between the 10 kD ΔtrxA and 5 kD Dead-box segments.

### 30 kD Protein (MWₐᵥₑ: 29,845.1)

The 30 kD protein contains three copies of the 10 kD ΔtrxA sequence and displays the following protein sequence:

(SEQ ID NO: 6)
SDKIIHLTDDSFDTDVLKADGAILVDFWAEWCGPCKMIAPILDEIA
DEYQGKLTVAKLNIDQNPGTAPKYGIRGGLGSDKIIHLTDDSFDTD
VLKADGAILVDFWAEWCGPCKMIAPILDEIADEYQGKLTVAKLNID
QNPGTAPKYGIRGIPTLLLFKNGEVAATKLGSDKIIHLTDDSFDTD
VLKADGAILVDFWAEWCGPCKMIAPILDEIADEYQGKLTVAKLNID
QNPGTAPKYGIRGIPTLLLFKNGEVAATKLGYNTDNKHHHHHH

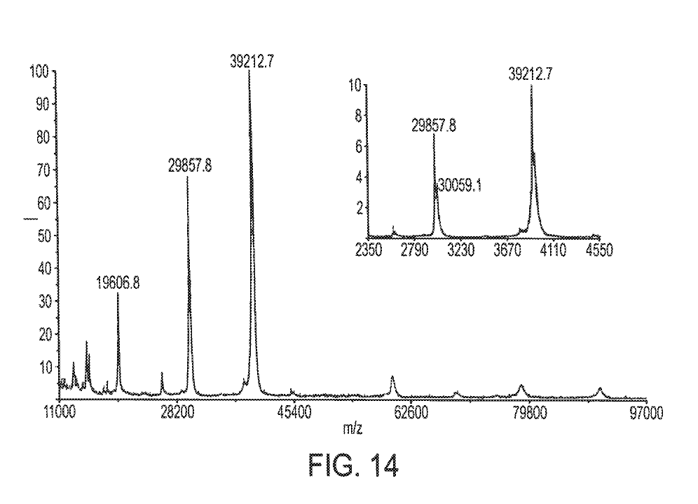

Internal calibration with the [M+H]⁺ and [M+2H]²⁺ peaks from aldolase (ALFA_RABIT, MW: 39,211.7), provided a molecular weight of 29,859 (error of 0.04%). See FIG. 14.

### 50 kD Protein

The 50 kD protein is predicted to have a molecular weight of 49,852.9, based on the following predicted sequence:

(SEQ ID NO: 7)
MSDKIIHLTDDSFDTDVLKADGAILVDFWAEWCGPCKMIAPILDEI
ADEYQGKLTVAKLNIDQNPGTAPKYGIRGIPTLLLFKKVPMGFSSE
DKGEWKLKLDNAGNGQAVIRFLPSKNDEQAPFAILVNHGFKKNGKW
YIETSSTHDYDSPVQYISKNDLGYNTDNKEYVLVKLKMGFSSEDKG
EWKLKLDNAGNGQAVIRFLPSKNDEQAPFAILVNHGFKKNGKWYIE
TSSTHDYDSPVQYISKNDLGYNTDNKEYVLVKLKMGFSSEDKGEWK
LKLDNAGNGQAVIRFLPSKNDEQAPFAILVNHGFKKNGKWYIETSS
THDYDSPVQYISKNDLGYNTDNKEYVLVKLKMGFSSEDKGEWKLKL
DNAGNGQAVIRFLPSKNDEQAPFAILVNHGFKKNGKWYIETSSTHD
YDSPVQYISKNDLGYNTDNKHHHHHH

The sequence corresponds to the first of the constructs shown below as “50 kD” proteins in Table 4. The acquired mass spectrometry data, [M+H]⁺ is 49,825, representing an error of 0.06%. The underlined sections of the above sequence correspond to the modified T4 gene 32 protein (see PCT International Publication No. WO98/30684, FIG. 1):

(SEQ ID NO: 8)
LGYNTDNKEYVLVKLKGFSSEDKGEWKLKLDNAGNGQAAIRFLPSK
NDEQAPFAILVNHGFKKNGKWYIETSSTHDYDSPVQYISKNDLG

### 70 kD Protein

PHS2_RABIT (MW: 97200.1 Da) was used for internal calibration of the 70-kDa protein, which is a chimeric construct of the components listed in Tables 3 and 4.

### 90 kD Protein

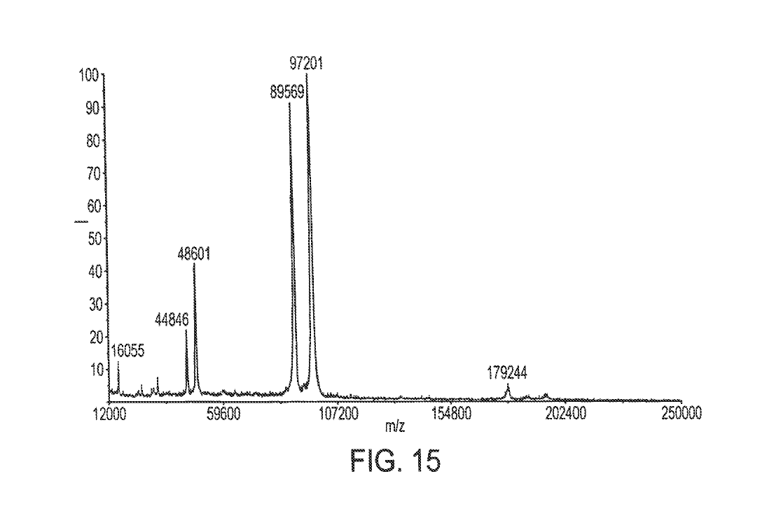

Internal calibration of the 90-kDa protein, which is a chimeric construct of the components listed in Tables 3 and 4, was carried out with the [M+H]⁺ and [M+2H]²⁺ Phosphorylase B (PHS2_RABIT, MW: 97200.1 Da) (FIG. 15).

### 160 kD Protein

Internal calibration of the 160 kDa protein calibrant, which is a chimeric construct of the components listed in Tables 3 and 4, was performed with the 90 kDa protein calibrant and verified by calibration against phosphorylase B.

TABLE 3
Vectors and cells used in the production of protein calibrants

| Protein | Version | Cell line |
|---|---|---|
| 10 kD | ptrxfusPRL10^{a} | DH10B c1 |
| 15 kD | pDB15^{b} | DH10B c1 |
| 20 kD | pDB20^{b} | DH10B c1 |
| 25 kD | ptrx5-25^{c} | STBL2 |
| 30 kD | ptrx30^{d} | STBL2 |
| 40 kD | ptrxfusPRL40^{e} | DH10B c1 |
| 50 kD | ptrx50^{d} | STBL2 |
| 50 kD | ptrxfusPRL50^{e} | STBL2 |
| 60 kD | ptrx60^{d} | DH10B c1 |
| 70 kD | ptrxfusPRL70^{e} | STBL2 |
| 80 kD | ptrx80^{d} | STBL2 |
| 90 kD | ptrx90^{d} | STBL2 |
| 100 kD | ptrxfusPRL100^{e} | STBL2 |
| 120 kD | ptrxfusPRL120^{e} | STBL2 |
| 160 kD | ptrxfusPRL160^{e} | STBL2 |
| 220 kD | ptrxfusPRL220^{e} | STBL2 |

^{a}10 kD from Thioredoxin sequence + 10 kD concatamers from gp32 sequence.
^{b}10 kD Thioredoxin + 5 kD from “DEAD” box protein sequence.
^{c}10 kD Thioredoxin + 5 kD concatamers of Kpn I Methylase sequence.
^{d}10 kD concatamers from the Thioredoxin sequence.
^{e}Same as Version a except that 24 bp deleted from the carboxyl end of the Thioredoxin sequence.

TABLE 4
Scheme for the production of fusion proteins
over a range of molecular weights. See also PCT
International Publication No. WO98/30684.

| | Number of copies of gene ligated to vector | | | |
|---|---|---|---|---|
| Molecular | 10 kD | 5 kD | 10 kD (T4 | 5 kD (KpnI |
| Weight | ΔtrxA | (Dead-box) | Gene 32) | Methylase) |
| 10 | 1 | 0 | 0 | 0 |
| 15 | 1 | 1 | 0 | 0 |
| 20 | 1 | 2 | 0 | 0 |
| 25 | 1 | 0 | 0 | 3 |
| 30 | 3 | 0 | 0 | 0 |
| 40 | 1 | 0 | 3 | 0 |
| 50 | 1 | 0 | 4 | 0 |
| 50 | 5 | 0 | 0 | 0 |
| 60 | 6 | 0 | 0 | 0 |
| 70 | 1 | 0 | 6 | 0 |
| 80 | 8 | 0 | 0 | 0 |
| 90 | 9 | 0 | 0 | 0 |
| 100 | 1 | 0 | 9 | 0 |
| 120 | 1 | 0 | 11 | 0 |
| 160 | 1 | 0 | 12 | 0 |
| 220 | 1 | 0 | 21 | 0 |

### Use of Proteins as Calibrants

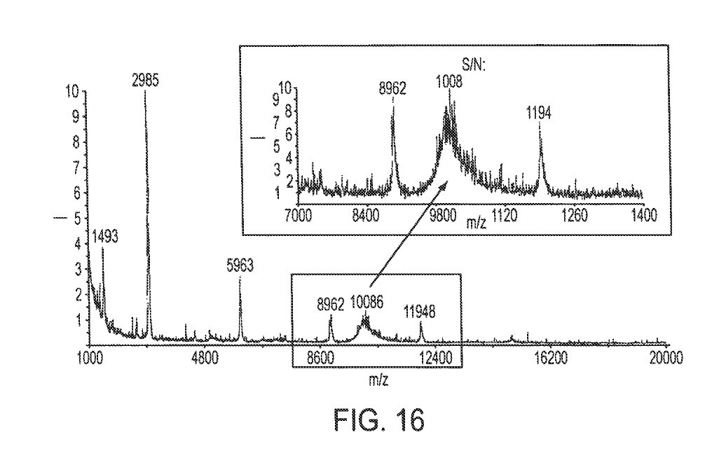

The calibrants can be used for both external and internal calibration. FIG. 16 shows a spectrum of vitamin k-dependent γ-glutamyl carboxylase (VKGC_HUMAN, Cbx) internally calibrated with the [3M+H]⁺ and [4M+H]⁺ peaks from the 30 kDa protein. The collection of standards allows multimers of a single protein to be used for calibration.

### Protein Concentration Assay

The concentrations of recovered calibrant proteins are determined by following standard protocol directions in the Pierce BCA Assay Kit, Part No. 23227, by creating a standard curve for BSA ranging from 0.1 mg/ml to 1.0 mg/ml. 25 uL aliquots of 1:2, 1:4 and 1:10 dilutions of the fractions listed in Table 2 (before and after the dialysis step used to exchange urea for TFA) are combined with 200 uL of 50:1 mixture of kit components A and B. These solutions are incubated in at 37° C. for 30 min. and spectrophotometric measurements are recorded at 562 nm using the Spectra Max 384 Plus from Molecular Devices.

### Stability of Calibrants

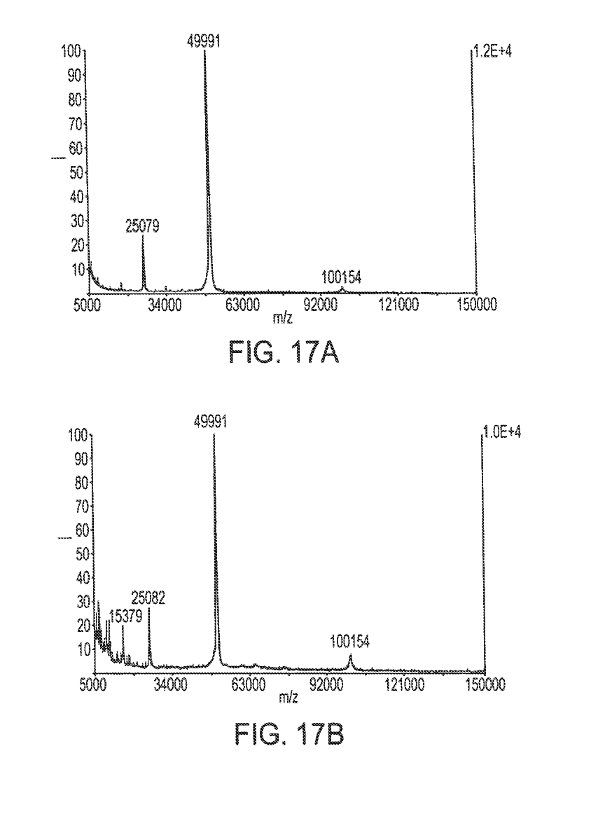

Stability studies of the calibrants were carried out over a 6 month period. A MALDI mass spectrum of each calibrant was acquired within the same day of preparation (purification of proteins from cell lysates and elution off of Ni-column). Samples were kept at 4° C., −20° C., and −80° C. The 30 and 90 kDa protein calibrants are stable for >3 months at 4° C. The other proteins are stable at −20° C. FIGS. 17a and 17b show the MALDI mass spectrum of Cal 50-kDa on the day of preparation and after 6 months at −20° C. Note that in both spectra, the signal intensity on the right Y axis is ≧1.0E+4.

### Protocol for Sample Preparation for Mass Spectrometry

All protein samples are prepared in 0.05% TFA, except for the 160 kDa protein calibrant, which is prepared in 0.1% TFA and 80 mM MES.

The SA solution is prepared by adding 700 μL of 0.1% TFA and 700 μL of ACN to a tube containing approximately 20±10% mg solid SA. The tube is vortexed for 1 minute and centrifuged for 10-15 seconds at 4000 rpm. The supernatant is used as diluent for the mass calibrant mixtures. The SA solution may be used for two weeks if kept at 4° C. after preparation. It is brought to room temperature for subsequent uses and vortexed for a minimum of 1-minute prior to use.

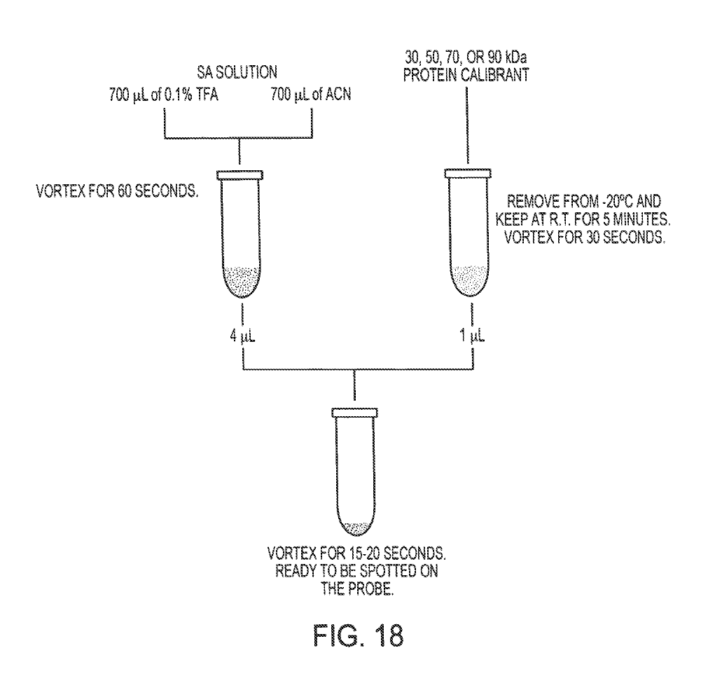

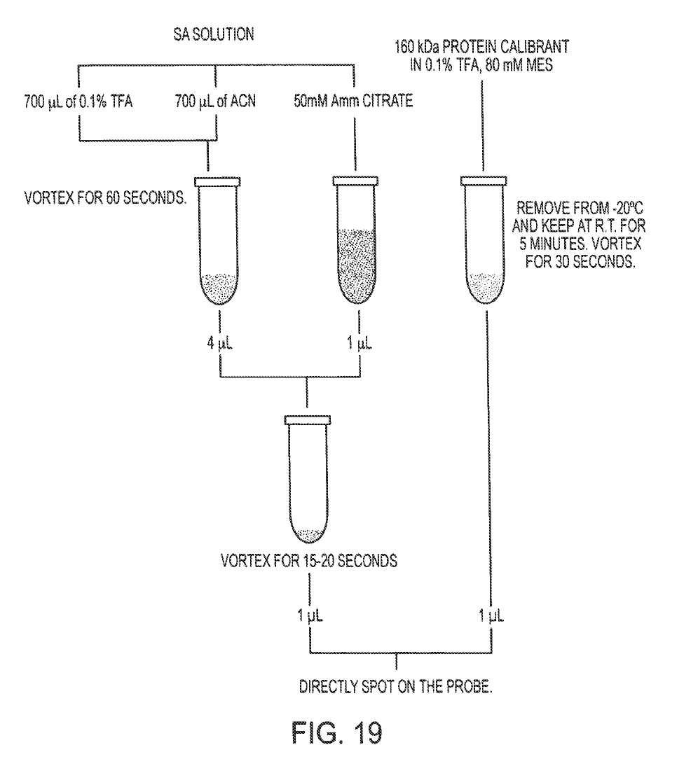

Solutions for the 30, 50, 70 and 90 kDa protein calibrants are prepared by removing the appropriate calibrant stock solution from −20° C. and holding it at room temperature for at least 5 minutes. The thawed solution is then vortexed for 30 seconds. One μL of the calibrant stock solution is diluted with 4 μL of the SA solution and vortexed for 10-15 seconds. A 1.0 μL aliquot of this mixture is loaded on the MALDI target plate and allowed to dry. For the 160 kDa protein calibrant, 4 μL of the SA solution is mixed with 1 μL of 50 mM ammonium citrate to give a supersaturated sinapinic acid solution with 10 mM ammonium citrate. This solution is mixed 1:1 with the 160 kDa calibrant stock solution directly on the MALDI probe. Diagrams of the two procedures are shown in FIGS. 18 and 19.

### Reduction of Laser-Induced Crystal Damage and Background Signal

Various intact proteins and protein mixtures were analyzed using three different preparations of sinapinic acid: freshly prepared dissolved in 0.1% TFA/50% ACN, dissolved in 0.1% TFA/50% ACN and stored at 4° C., and dissolved in 0.1% TFA/50% ACN and diluted with ammonium citrate and MES to a final concentration of 5 mM ammonium citrate and 40 mM MES. The sample/matrix mixtures were analyzed using several MALDI-TOF instruments including the Voyager DE-STR, the Voyager DE and the ABI 4700 TOF/TOF.

The presence of ammonium citrate and MES reduced laser-induced crystal damage and matrix background noise and improved the signal response of low-abundance analytes. In addition, protein peaks were observed without satellites or adducts. Spotted samples may be archived on a target plate and analyzed repeatedly. A prepared sinapinic acid matrix may be stored at 4° C. for at least 6 months.

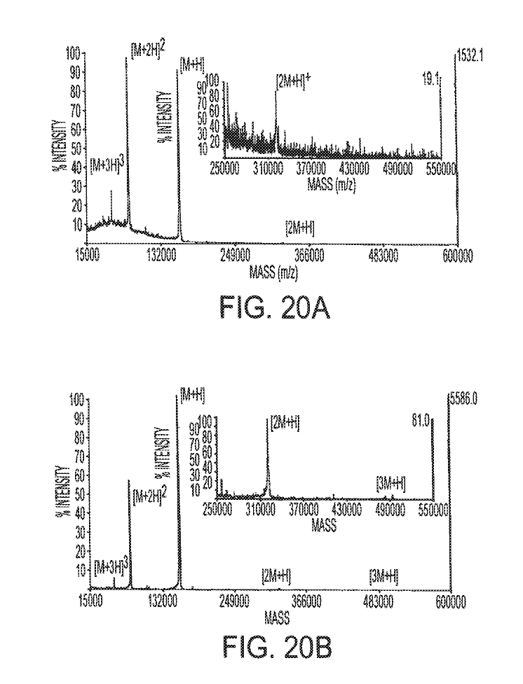

FIG. 20 shows an analysis of (A) the 160 kDa protein in 0.1% TFA/sinapinic acid dissolved in 0.1% TFA/50% ACN and (B) the 160 kDa protein in 80 mM MES/0.1% TFA/sinapinic acid dissolved in 0.1% TFA/50% ACN/10 mM ammonium citrate. The presence of MES and ammonium citrate (final concentration of 40 mM MES and 5 mM ammonium citrate) reduces the matrix background noise and increases the signal intensity of the analyte, affording detection of the dimer [2M+H]⁺ and trimer [3M+H]⁺ at 318,160 and 477,241 Da, respectively.

### Summary

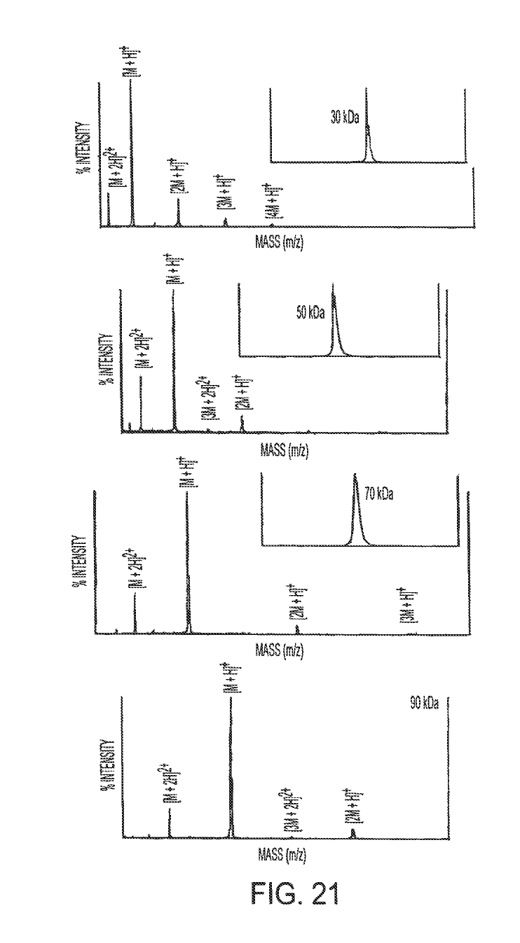

Each of the protein calibrants described in this Example corresponds to a single, highly purified protein from the BenchMark™ Protein Ladder (Invitrogen Corp., Carlsbad, Calif.) gel migration standards set. In addition to the singly-charged molecular ion, [M+H]⁺, the [M+2H]²⁺, [2M+H]⁺, [M+3H]³⁺, [3M+H]⁺ ions are generally abundant enough to be used for calibration. The following ions are also present in mass spectra of the higher mass protein calibrants at lower abundance: [3M+2H]²⁺, [2M+3H]³⁺, [3M+4H]⁴⁺, and [2M+5H]⁵⁺. FIG. 21 further illustrates the purity of the protein calibrants, which may be used to calibrate intact proteins in the range 15 to 300 kDa.

### Example 2

### MES, MOPS and Related Compounds as MALDI Matrix Additives

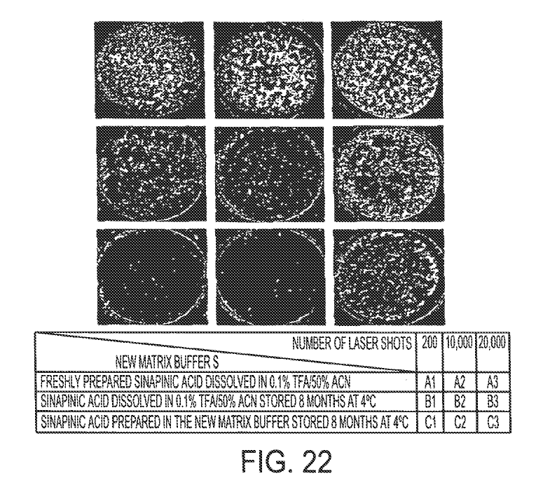

It was observed that intact protein samples dissolved in the buffer 2-(N-Morpholino)ethanesulfonic Acid (MES) produce co-crystals when co-mixed with the SA matrix for MALDI-MS analysis. An experiment was carried out to determine the ability of MES to resist laser ablation under MALDI-MS conditions. SA dissolved in 50% acetonitrile (ACN)/0.1% TFA was compared with SA dissolved in 50% ACN/0.1% TFA/40 mM MES. FIG. 22 shows images of 1 μL spots of SA dissolved in the absence or presence of MES. Even after 20,000 laser shots, the SA/MES sample (C3) displays marked resistance to laser ablation compared to SA spots without MES (A3 and B3). Thus, MES appears to stabilize the physical structure of the SA crystal under MALDI-MS conditions.

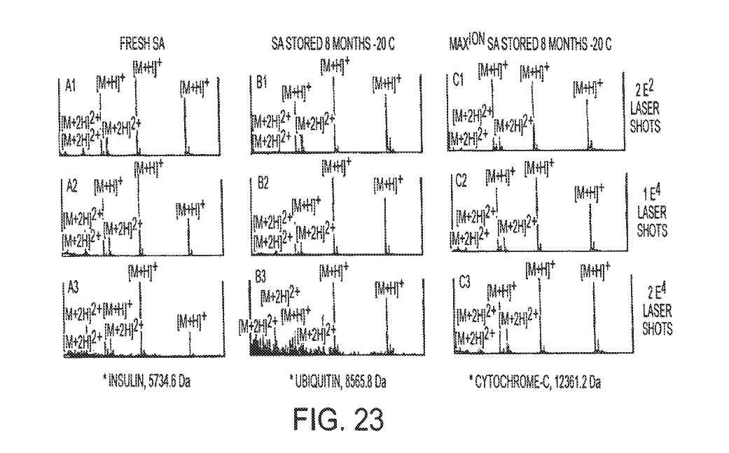

The experiment was repeated with co-spotting of a protein mix (insulin, ubiquitin, cytochrome-c) and using MALDI-MS spectral quality as an assay of the stability of SA/MES crystals. FIG. 23 illustrates how the signal-to-noise of the various protein analyte peaks diminishes with increasing number of laser shots for SA in the absence of MES (A1-A3, B1-B3). However, SA in the presence of MES was able to resist the loss in signal-to-noise as the number of laser shots increased (column C). Thus, the ability of MES to resist laser-induced crystal damage also lessens the loss of signal during increasing exposure to laser irradiation.

Experiments with the buffer MOPS (3-(N-Morpholino)propanesulfonic acid), which differs from MES only by an additional (—CH₂) moiety in the carbon chain between the morpholino and the sulfonate moieties, were also carried out. Although somewhat less pronounced than MES, MOPS also enhanced stability to laser-induced crystal damage.

### Example 3

### Effect of MES, MOPS and Related Compounds on Signal-to-Noise Ratio

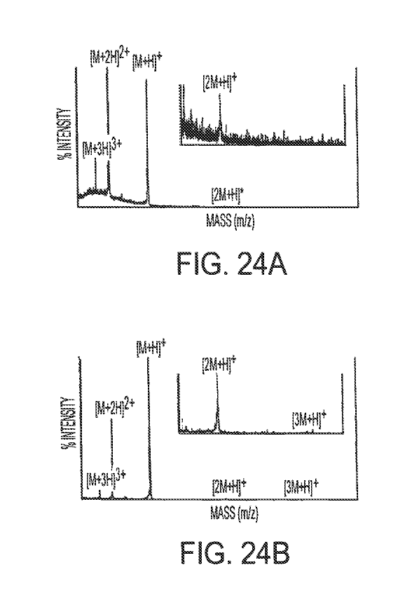

Detection of high molecular weight proteins by MALDI-TOF-MS can be especially challenging due to the inherent poor ionization efficiency. In order to detect these large proteins, higher laser intensities, longer acquisitions and more spectra are needed to sum and average spectra in order to maximize signal-to-noise. FIG. 24 illustrates an example of a MALDI-TOF analysis of a high molecular weight protein and how the MES matrix additive can enhance the signal intensities of low abundance proteins. Spectrum A shows the prevalence of noise and the resulting perturbation of the baseline. Spectrum B shows how MES can practically eliminate the baseline perturbation and markedly improve the signal-to-noise of the analyte peaks. Further, MES allows the improved mass measurement of the dimer peak (at 318,160), and even the identification of the trimer (at 477,241)(insets).

### Example 4

### Structures of MES, MOPS and Related Compounds

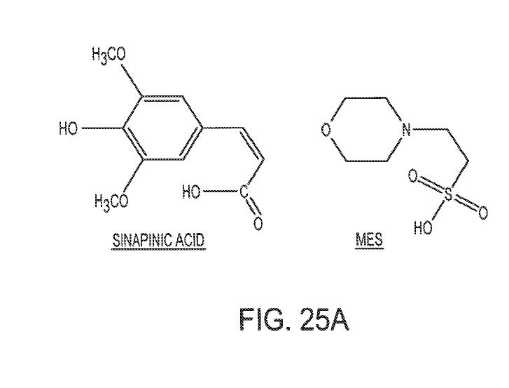

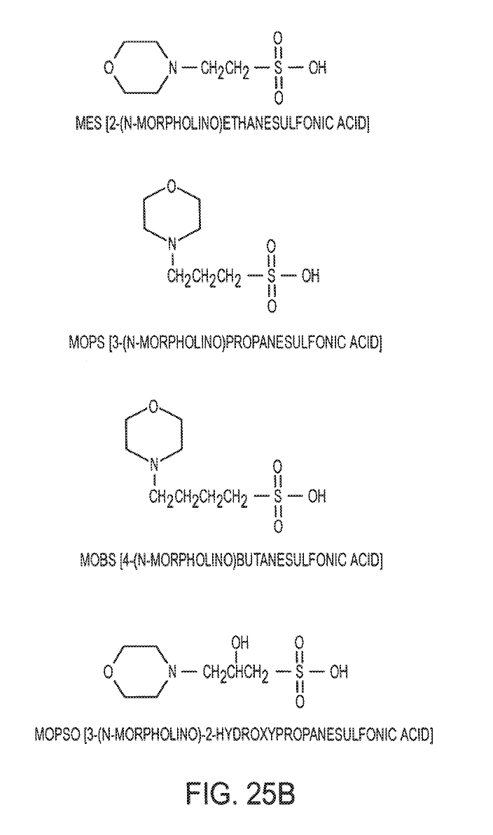

FIG. 25(B) shows the chemical structures of the MES (2-(N-Morpholino)ethanesulfonic Acid), MOPS (3-(N-Morpholino)propanesulfonic Acid), MOPSO (3-(N-Morpholino)-2-hydroxypropanesulfonic Acid) and MOBS (4-(N-Morpholino)butanesulfonic Acid) buffers. It is believed that these and other morpholino-sulfonic acids, as well as other related compounds, may also be useful as MALDI matrix additives.

One type of matrix additive of the invention has the structure

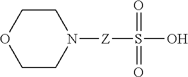

Wherein Z=[CH₂]ₐ—[CH—OH]_{b}—[CH₂]_{c}, and wherein:
a ═0 to 25,
b=0 to 25,
c=0 to 25,
with the exception that, if b=0, a and c cannot both be 0.

By way of non-limiting example, in the structure of MES, a=2, b=0 and c=0; in MOPS, a=3, b=0 and c=0; in MOPSO a=1, b=1 and c=1; and in MOBS, a=4, b=0 and c=0, See FIG. 21 for further details.

All patents, patent publications, and other published references mentioned herein are hereby incorporated by reference in their entireties as if each had been individually and specifically incorporated by reference herein.

While specific examples have been provided, the above description is illustrative and not restrictive. Any one or more of the features of the previously described embodiments can be combined in any manner with one or more features of any other embodiments in the present invention. Furthermore, many variations of the invention will become apparent to those skilled in the art upon review of the specification. The scope of the invention should, therefore, be determined by reference to the appended claims, along with their full scope of equivalents.

1. A calibrant composition comprising:
a plurality of recombinant proteins spanning a predefined molecular mass range and separated by one or more molecular mass increments; and
an energy-absorbing molecule.

2-9. (canceled)

10. The calibrant composition of claim 1, comprising three or more recombinant proteins.

11-18. (canceled)

19. The calibrant composition of claim 10, wherein the same molecular mass increment separates at least three adjacent recombinant proteins.

20. The calibrant composition of claim 19, wherein the same molecular mass increment that separates at least three adjacent recombinant proteins is about 20 kD.

21-25. (canceled)

26. The calibrant composition of claim 1, further comprising a matrix buffer formulation for enhancing detection of high molecular weight proteins.

27. The calibrant composition of claim 26, wherein the matrix buffer formulation comprises at least one zwitterionic compound.

28. The calibrant composition of claim 27, wherein said at least one zwitterionic compound is a morpholinesulfonic acid compound.

29. The calibrant composition of claim 28, wherein said morpholino-sulfonic acid compound is 2-morpholinoethanesulfonic acid monohydrate (MES), 3-morpholinopropanesulfonic acid (MOPS), 4-N morpholino)butanesulfonic acid (MOBS), or 3-N 2-hydroxypropanesulfonic acid (MOPSO).

30. The calibrant composition of claim 29, wherein said morpholino-sulfonic acid compound is 2-morpholinoethanesulfonic acid monohydrate (MES).

31. The calibrant composition of claim 27, further comprising at least one salt.

32. The calibrant composition of claim 31, wherein the at least one salt is a salt of a trivalent anion.

33. The calibrant composition of claim 31, wherein the at least one salt is a salt of an organic acid, a tricarboxylic acid, citrate, phosphate, diphosphoglycerate, aconitic acid, or 1-carboxyglutamic acid.

34. The calibrant composition of claim 31, wherein the at least one salt is ammonium citrate.

35-50. (canceled)

51. A method of calibrating a mass spectrometer, comprising:
providing a calibrant composition that comprises a plurality of recombinant proteins spanning a predefined molecular mass range and separated by one or more molecular mass increments, wherein the recombinant proteins are homogeneous by mass spectrometry, further wherein at least one of the proteins is a chimeric protein or a multimeric protein, and
an energy-absorbing molecule;
applying two or more of the recombinant proteins in association with an energy-absorbing molecule of the calibrant composition on a mass spectrometer probe; and
performing mass spectrometry on the two or more recombinant proteins of the composition to obtain a mass spectrometry profile of at least two of the proteins of the composition.

52-57. (canceled)

58. A method of calibrating a mass spectrometer, comprising:
providing a calibrant composition that comprises:
a plurality of recombinant proteins spanning a predefined molecular mass range and separated by one or more molecular mass increments, wherein the recombinant proteins are homogeneous by mass spectrometry, further wherein at least one of the proteins is a chimeric protein or a multimeric protein,
an energy-absorbing molecule, and
a matrix buffer formulation for enhancing detection of high molecular weight proteins;
adding the energy-absorbing molecule to two or more of the multiplicity of recombinant proteins;
adding to at least one of the two or more of the multiplicity of recombinant proteins a matrix buffer formulation; and
using a mass spectrometer to perform MALDI mass spectrometry on the two or more recombinant proteins to calibrate the mass spectrometer.

59-64. (canceled)

65. A kit comprising:
a plurality of recombinant proteins spanning a predefined molecular mass range and separated by one or more molecular mass increments, wherein the recombinant proteins are homogeneous by mass spectrometry, and
an energy-absorbing molecule.

66-67. (canceled)

68. The kit of claim 65, wherein the plurality of recombinant proteins comprises three or more recombinant proteins.

69-71. (canceled)

72. The kit of claim 65, wherein the predefined range spans to at least about 70 kD.

73. The kit of claim 72, wherein the predefined range spans to at least about 90 kD.

74. The kit of claim 73, wherein the predefined range spans to at least about 100 kD.

75-78. (canceled)

79. The kit of claim 68, wherein the same molecular mass increment separates at least three adjacent recombinant proteins.

80-89. (canceled)

90. The kit of claim 65, further comprising, a matrix buffer formulation for enhancing detection of high molecular weight molecules.

91. The kit of claim 90, wherein the matrix buffer formulation comprises at least one zwitterionic compound that can protect an EAM crystal from laser induced damage.

92. The kit of claim 91, wherein said at least one zwitterionic compound is 2-morpholinoethanesulfonic acid monohydrate (MES), 3-morpholinopropanesulfonic acid (MOPS), 4-N morpholino)butanesulfonic acid (MOBS) or 3-N 2-hydroxypropanesulfonic acid (MOPSO).

93. The kit of claim 91, wherein said matrix buffer formulation further comprises at least one salt.

94-145. (canceled)

146. A method of performing mass spectrometry on an analyte, comprising:
providing at least one analyte;
adding at least one energy absorbing molecule and at least one zwitterionic compound that can reduce laser-induced energy absorbing molecule crystal damage to the at least one analyte; and
performing matrix-assisted laser desorption/ionization mass spectrometry (MALDI-MS) on the at least one analyte.

147. The method of claim 146, wherein the at least one analyte comprises protein, nucleic acid, lipid, or carbohydrate.

148. The method of claim 147, wherein the molecular mass of the at least one molecule is greater than or equal to 20 kD.

149. The method of claim 146, wherein at least one energy-absorbing molecule is sinnapinic acid (dimethoxyhydroxycinnamic acid); alpha-cyano-4-hydroxycinnmic acid; 2,5 dihydroxybenzoic acid (2,5 DHB); 2-(4-hydroxy-phenol-azo)benzoic acid (HABA); fucose mixtures with DHBi 2-hydroxy-5-methoxybenzoic acid; 5 methoxysalicylic acid; 2,4,6 trihydroxyacetophenonei 2,6 dihydroxyacetophenone; or 3 hydroxypicolinic acid (HPA).

150. The method of claim 146, wherein the at least one zwitterionic compound is a morpholino sulfonic acid.

151. The method of claim 150, wherein the morpholino-sulfonic acid is 2-morpholinoethanesulfonic acid monohydrate (MES) or 3-morpholinopropanesulfonic acid (MOPS).

152. The method of claim 151, wherein the concentration of the morpholino-sulfonic acid is from about 10 millimolar to about 500 millimolar.

153. The method of claim 151, wherein the morpholino-sulfonic acid is 2-morpholinoethanesulfonic acid monohydrate (MES).

154-174. (canceled)


SEQUENCE LISTING (9 sequences)

SEQ ID NO: 1 - protein, 91 aa, Artificial Sequence
  Description of Artificial Sequence Synthetic protein sequence
SDKIIHLTDDSFDTDVLKADGAILVDFWAEWCGPCKMIAPILDEIADEYQGKLTVAKLNIDQNPGTAPKYGIRGIPTLLLFKNGEHHHHHH

SEQ ID NO: 2 - protein, 75 aa, Artificial Sequence
  Description of Artificial Sequence Synthetic protein sequence
MSDKIIHLTDDSFDTDVLKADGAILVDFWAEWCGPCKMIAPILDEIADEYQGKLTVAKLNIDQNPGTAPKYGIRG

SEQ ID NO: 3 - protein, 177 aa, Artificial Sequence
  Description of Artificial Sequence Synthetic protein sequence
SDKIIHLTDDSFDTDVLKADGAILVDFWAEWCGPCKMIAPILDEIADEYQGKLTVAKLNIDQNPGTAPKYGIRGGLGKLTNPEVELPNAELLGKRRLEKFAAKVQQQLESSDLDQYRALLGKLTNPEVELPNAELLGKRRLEKFAAKVQQQLESSDLDQYRALLGYNTDNKHHHHHH

SEQ ID NO: 4 - protein, 43 aa, Artificial Sequence
  Description of Artificial Sequence Synthetic protein sequence
KLTNPEVELPNAELLGKRRLEKFAAKVQQQLESSDLDQYRALL

SEQ ID NO: 5 - protein, 41 aa, Artificial Sequence
  Description of Artificial Sequence Synthetic protein sequence
MKRRLEKFAAKVQQQLESSDLDQYRALLGYNTDNKHHHHHH

SEQ ID NO: 6 - protein, 273 aa, Artificial Sequence
  Description of Artificial Sequence Synthetic protein sequence
SDKIIHLTDDSFDTDVLKADGAILVDFWAEWCGPCKMIAPILDEIADEYQGKLTVAKLNIDQNPGTAPKYGIRGGLGSDKIIHLTDDSFDTDVLKADGAILVDFWAEWCGPCKMIAPILDEIADEYQGKLTVAKLNIDQNPGTAPKYGIRGIPTLLLFKNGEVAATKLGSDKIIHLTDDSFDTDVLKADGAILVDFWAEWCGPCKMIAPILDEIADEYQGKLTVAKLNIDQNPGTAPKYGIRGIPTLLLFKNGEVAATKLGYNTDNKHHHHHH

SEQ ID NO: 7 - protein, 440 aa, Artificial Sequence
  Description of Artificial Sequence Synthetic protein sequence
MSDKIIHLTDDSFDTDVLKADGAILVDFWAEWCGPCKMIAPILDEIADEYQGKLTVAKLNIDQNPGTAPKYGIRGIPTLLLFKKVPMGFSSEDKGEWKLKLDNAGNGQAVIRFLPSKNDEQAPFAILVNHGFKKNGKWYIETSSTHDYDSPVQYISKNDLGYNTDNKEYVLVKLKMGFSSEDKGEWKLKLDNAGNGQAVIRFLPSKNDEQAPFAILVNHGFKKNGKWYIETSSTHDYDSPVQYISKNDLGYNTDNKEYVLVKLKMGFSSEDKGEWKLKLDNAGNGQAVIRFLPSKNDEQAPFAILVNHGFKKNGKWYIETSSTHDYDSPVQYISKNDLGYNTDNKEYVLVKLKMGFSSEDKGEWKLKLDNAGNGQAVIRFLPSKNDEQAPFAILVNHGFKKNGKWYIETSSTHDYDSPVQYISKNDLGYNTDNKHHHHHH

SEQ ID NO: 8 - protein, 90 aa, Artificial Sequence
  Description of Artificial Sequence Synthetic protein sequence
LGYNTDNKEYVLVKLKGFSSEDKGEWKLKLDNAGNGQAAIRFLPSKNDEQAPFAILVNHGFKKNGKWYIETSSTHDYDSPVQYISKNDLG

SEQ ID NO: 9 - protein, 6 aa, Artificial Sequence
  Description of Artificial Sequence Synthetic 6xHis tag
HHHHHH